(19) United States
(12) Patent Application Publication
(10) Pub. No.: US 2025/0083444 A1
(43) Pub. Date: Mar. 13, 2025

(54) TANK INCLUDING FIRST AND SECOND COMMUNICATION PARTS PROVIDING COMMUNICATION BETWEEN INTERIOR AND EXTERIOR OF FIRST AND SECOND STORAGE CHAMBERS, RESPECTIVELY

(71) Applicant: BROTHER KOGYO KABUSHIKI KAISHA, Nagoya (JP)

(72) Inventors: Fumiya NAKAMURA, Nagoya (JP); Masahiro HAYASHI, Anjo (JP); Naoya OKAZAKI, Hashima (JP); Yuma TANABE, Nagoya (JP); Satoru OKI, Nagoya (JP); Yuji FUKUTA, Nagoya (JP)

(73) Assignee: BROTHER KOGYO KABUSHIKI KAISHA, Nagoya (JP)

(21) Appl. No.: 18/829,603

(22) Filed: Sep. 10, 2024

(30) Foreign Application Priority Data
Sep. 11, 2023 (JP) 2023-147209

(51) Int. Cl. B41J 2/175

(52) U.S. Cl. CPC B41J 2/17509; B41J 2/17596

(57) ABSTRACT

A tank includes a first storage chamber, a second storage chamber, a first communication part to which a first liquid bottle is connectable, and a second communication part to which a second liquid bottle is connectable. The first storage chamber is defined by a first surface and a second surface facing the first surface in a first direction. The second storage chamber is defined by a third surface and a fourth surface facing the third surface in the first direction. The first and second storage chambers are juxtaposed in the first direction. In the first direction, a center of the first communication part in the first direction is offset from a center of the first storage chamber in the first direction. In the first direction, a center of the second communication part in the first direction is offset from a center of the second storage chamber in the first direction.

### REFERENCE TO RELATED APPLICATIONS

This application claims priority from Japanese Patent Application No. 2023-147209 filed on Sep. 11, 2023. The entire content of the priority application is incorporated herein by reference.

### BACKGROUND ART

A conventionally known liquid consuming device is provided with a three-color tank. The three-color tank has three storage chambers that respectively store ink in one of the colors cyan, magenta, and yellow. The three storage chambers of the three-color tank are juxtaposed in the width direction of the liquid consuming device. Three injection ports that provide communication between the interior and exterior of respective storage chambers are positioned in the top wall of the three-color tank. Each injection port communicates with a corresponding one of the three storage chambers. The injection ports are spaced at intervals in the width direction of the liquid consuming device. A cover is arranged over the top wall of the three-color tank to cover the three injection ports. Three caps are fixed to the bottom surface of the cover for respectively closing the three injection ports. The cover is pivotable between a closed position in which the three caps close the three injection ports and an open position in which all three injection ports are open.

### SUMMARY

The conventional three-color tank requires that the inner diameter of each injection port be of a certain size in order to facilitate the operation of injecting ink into each storage chamber from a liquid bottle and the operation of mounting the caps on the injection ports, for example. This requirement tends to increase the widthwise dimension of the cover that covers the three injection ports and to increase the widthwise dimension of each storage chamber, since all three injection ports are provided in the top wall of the three-color tank, leading to an increased widthwise dimension of the liquid consuming device provided with the tank.

In view of the foregoing, it is an object of the present disclosure to provide a tank that can suppress an increase in the widthwise dimension of the liquid consuming device in which the tank is provided.

In order to attain the above and other objects, according to one aspect, the present disclosure provides a tank for use in a liquid consuming device. The liquid consuming device is configured to consume liquid. The tank includes a first surface, a second surface, a third surface, and a fourth surface, a first storage chamber, a second storage chamber, a first communication part, and a second communication part. The second surface faces the first surface in a first direction. The first direction corresponds to a widthwise direction of the liquid consuming device when the tank is in use in the liquid consuming device. The fourth surface faces the third surface in the first direction. The first storage chamber is defined by the first surface and the second surface. The second storage chamber is defined by the third surface and the fourth surface. The second storage chamber and the first storage chamber are juxtaposed in the first direction. A first liquid bottle storing liquid is connectable to the first communication part. The first communication part provides communication between an interior of the first storage chamber and an exterior of the first storage chamber. A second liquid bottle storing liquid is connectable to the second communication part. The second communication part provides communication between an interior of the second storage chamber and an exterior of the second storage chamber. In the first direction, a center of the first communication part in the first direction is offset from a center of the first storage chamber in the first direction. In the first direction, a center of the second communication part in the first direction is offset from a center of the second storage chamber in the first direction.

In the above structure, the distance in the first direction between the center of the first communication part in the first direction and the center of the second communication part in the first direction can be made shorter than if the center of the first communication part were aligned with the center of the first storage chamber and the center of the second communication part were aligned with the center of the second storage chamber. Therefore, if a cover is provided to cover the first and second communication parts, for example, the dimension of the cover in the first direction can be shortened, thereby suppressing an increase in the widthwise dimension of the liquid consuming device.

According to another aspect, the present disclosure provides a tank to which a liquid bottle storing liquid is connectable. The tank is for use in a liquid consuming device configured to consume liquid. The tank includes a first surface, a second surface, a third surface, a fourth surface, a first storage chamber, a second storage chamber, a first communication part, and a second communication part. The second surface faces the first surface in a first direction. The first direction corresponds to a widthwise direction of the liquid consuming device when the tank is in use in the liquid consuming device. The fourth surface faces the third surface in the first direction. The first storage chamber is defined by the first surface and the second surface. The second storage chamber is defined by the third surface and the fourth surface. The second storage chamber and the first storage chamber are juxtaposed in the first direction. The first communication part provides communication between an interior of the first storage chamber and an exterior of the first storage chamber. The second communication part provides communication between an interior of the second storage chamber and an exterior of the second storage chamber. A portion of the first communication part and a portion of the second storage chamber are at the same position in the first direction.

In the above structure, since a portion of the first communication part and a portion of the second storage chamber are at the same position in the first direction, the first communication part is positioned to span between the first storage chamber and the second storage chamber in the first direction. Accordingly, the first communication part can be arranged without increasing the length of the first storage chamber in the first direction, thereby suppressing an increase in the widthwise dimension of the liquid consuming device.

According to still another aspect, the present disclosure provides a tank to which a liquid bottle storing liquid is connectable. The tank is for use in a liquid consuming device configured to consume liquid. The tank includes a first surface, a second surface, a third surface, a fourth surface, a first storage chamber, a second storage chamber, a first communication part, and a second communication part. The second surface faces the first surface in a first direction. The first direction corresponds to a widthwise direction of the liquid consuming device when the tank is in use in the liquid consuming device. The fourth surface faces the third surface in the first direction. The first storage chamber is defined by the first surface and the second surface. The second storage chamber is defined by the third surface and the fourth surface. The second storage chamber and the first storage chamber are juxtaposed in the first direction. The first communication part provides communication between an interior of the first storage chamber and an exterior of the first storage chamber. The second communication part provides communication between an interior of the second storage chamber and an exterior of the second storage chamber. In the first direction, a center of the first communication part in the first direction is offset from a center of the first storage chamber in the first direction. In the first direction, a center of the second communication part in the first direction is offset from a center of the second storage chamber in the first direction. A manner in which the center of the first communication part is offset from the center of the first storage chamber is different from a manner in which the center of the second communication part is offset from the center of the second storage chamber.

In the above structure, the distance in the first direction between the center of the first communication part in the first direction and the center of the second communication part in the first direction can be made shorter than if the center of the first communication part were offset from the center of the first storage chamber in a direction from the second storage chamber toward the first storage chamber and the center of the second communication part were offset from the center of the second storage chamber in a direction from the first storage chamber toward the second storage chamber. Therefore, if a cover is provided to cover the first and second communication parts, for example, the dimension of the cover in the first direction can be shortened, thereby suppressing an increase in the widthwise dimension of the liquid consuming device.

### BRIEF DESCRIPTION OF DRAWINGS

FIG. 1 is a perspective view of the external appearance of a multifunction peripheral 10.

FIG. 2 is a longitudinal cross-sectional view schematically illustrating the internal structure of a printing unit 11.

FIG. 3 is a plan view illustrating the arrangement of a carriage 23 and an ink tank 100.

FIG. 4 is a perspective view of an ink tank set 51.

FIG. 5 is a perspective view of the ink tank 100.

FIG. 6 is a top view of a tank cap 127.

FIG. 7 is a front view of the tank cap 127.

FIG. 8 is a right-side view of the tank cap 127.

FIG. 9 is a rear view of the tank cap 127.

FIG. 10 is a bottom view of the tank cap 127.

FIG. 11 is a longitudinal cross-sectional view of the tank cap 127.

FIG. 12 is a partial cross-sectional view of a state in which the tank caps 127 are mounted on annular walls 122A, 122B, 122C, and 122D.

FIG. 13 is a longitudinal cross-sectional view of a state in which the tank caps 127 are mounted on the annular walls 122A, 122B, 122C, and 122D.

FIG. 14 is a perspective view of a liquid bottle 80.

FIG. 15 is a schematic diagram illustrating the center A1 of a protrusion 94.

FIG. 16 is a longitudinal cross-sectional view of the liquid bottle 80 in a state where a valve 161 is in a closed position.

FIG. 17 is a is a longitudinal cross-sectional view of the liquid bottle 80 in a state where the valve 161 is in an open position.

FIG. 18 is a cross-sectional view illustrating the area S1 of an air channel G and the area S2 of an ink channel F.

FIG. 19 is a cross-sectional view illustrating that the left-right centers C1, C2, C3, and C4 of the respective annular walls 122A, 122B, 122C, and 122D are offset rightward from the left-right centers D1, D2, D3, and D4 of respective ink chambers 111A, 111B, 111C, and 111D.

FIG. 20A is a schematic diagram illustrating the positional relationship between a tank tube 115C and a communication opening 119C in the inward area of the annular wall 122C, and specifically illustrating that the center K3 of the annular 122C is positioned further frontward than the center T3 of the tank tube 115C.

FIG. 20B is a schematic diagram illustrating an assumed comparative example in which the center K3 of the annular 122C is aligned with the center T3 of the tank tube 115C.

FIG. 21 is a cross-sectional view of a variation in which the four annular walls 122A, 122B, 122C, and 122D are omitted.

FIG. 22 is a cross-sectional view of a variation in which the four annular walls 122A, 122B, 122C, and 122D and the four tank tubes 115A, 115B, 115C, and 115D are omitted.

FIG. 23 is a cross-sectional view of a variation in which the four annular walls 122A, 122B, 122C, and 122D and the communication openings 119A, 119B, 119C, and 119D are omitted.

FIG. 24 is a cross-sectional view of a variation in which the ink chambers 111A, 111B, 111C, and 111D are arranged with intervals in the left-right direction.

FIG. 25 is a cross-sectional view of a cap according to a variation.

FIG. 26 is a cross-sectional view of a variation in which the left-right center C2 of the annular wall 122B is offset leftward from the left-right center D2 of the ink chamber 111B and the left-right center C3 of the annular wall 122C is offset rightward from the left-right center D3 of the ink chamber 111C.

FIG. 27 is a cross-sectional view of a variation in which the left-right centers C15, C16, C17, and C18 of respective atmospheric communication ports 112A, 112B, 112C, and 112D are offset rightward from the left-right centers D1, D2, D3, and D4 of the respective ink chambers 111A, 111B, 111C, and 111D.

FIG. 28 is a cross-sectional view of a variation in which the left-right centers C21, C22, C23, and C24 of respective outflow tubes 124A, 124B, 124C, and 124D are offset rightward from the left-right centers D1, D2, D3, and D4 of the respective ink chambers 111A, 111B, 111C, and 111D.

FIG. 29 is a cross-sectional view of a variation in which atmospheric communication passages 181A, 181B, 181C, and 181D are connected to the atmospheric communication ports 112A, 112B, 112C, and 112D, respectively.

FIG. 30 is a cross-sectional view of a variation in which four ink tubes 32 are connected the corresponding outflow tubes 124A, 124B, 124C, and 124D by a connecting member 171.

### DESCRIPTION

Below, an embodiment of the present disclosure will be described. It should be understood that the following embodiment is merely one example of the disclosure, and that this embodiment may be modified as appropriate without departing from the spirit of the disclosure. In the following description, both directions of a bidirectional arrow are collectively referred to as a “direction.” In other words, the upward direction and the downward direction are both components of the up-down direction and are opposite to each other. Similarly, the leftward direction and the rightward direction are both components of the left-right direction and are opposite to each other, and the frontward direction (i.e., the forward direction) and the rearward direction are both components of the front-rear direction and are opposite to each other. Additionally, the up-down direction in this embodiment corresponds to the direction of gravity, while the front-rear direction and left-right direction correspond to horizontal directions.

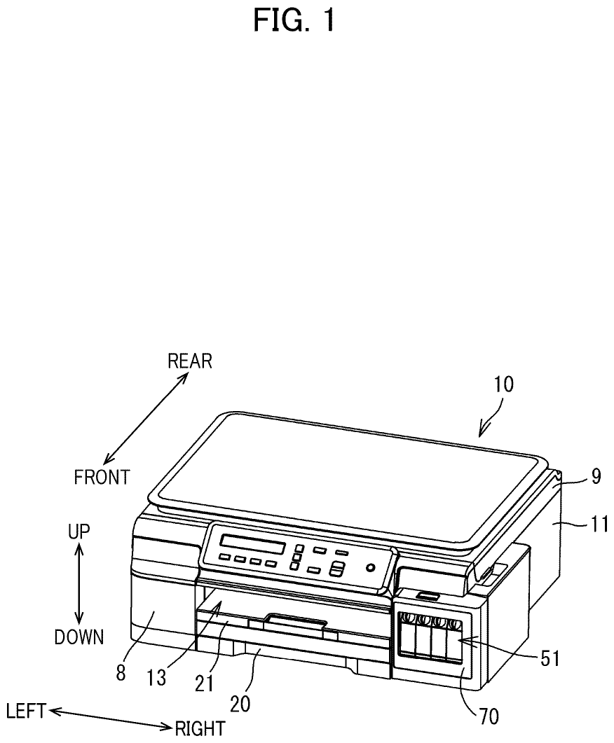

The up-down direction is further defined based on the state or orientation of a multifunction peripheral 10 when the multifunction peripheral 10 is installed and ready for use; the front-rear direction is defined on the assumption that the side of the multifunction peripheral 10 having an opening 13 is the front side nearest the user; and the left-right direction is defined based on the perspective of the user viewing the multifunction peripheral 10 from the front side. The state of the multifunction peripheral 10 in FIG. 1 may be described as the “operable state.” The orientation of the multifunction peripheral 10 in FIG. 1 may be described as the “operable orientation.” The near side of the multifunction peripheral 10 having the opening 13 is the front surface of the multifunction peripheral 10. The left-right direction is an example of the widthwise direction.

In addition, for each component in the multifunction peripheral 10, the center of the component in the left-right direction will be referred to simply as the “left-right center of the component,” the position of the component in the left-right direction will be referred to simply as the “left-right position of the component,” the dimension of the component in the left-right direction will be referred to simply as the “left-right dimension of the component,” and the length of the component in the left-right direction will be referred to simply as the “left-right length of the component.” The same applies to the up-down direction and the front-rear direction.

### <Overall Configuration of Multifunction Peripheral 10>

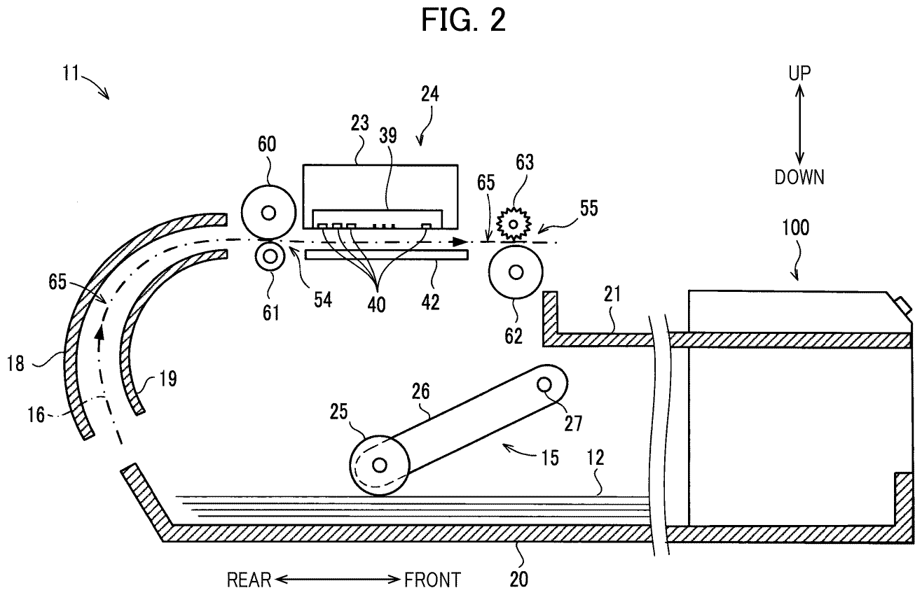

As shown in FIG. 1, the multifunction peripheral 10 includes a casing 8 having a general parallelepiped shape. The multifunction peripheral 10 further includes a scanning unit 9 and a printing unit 11 arranged in the internal space of the casing 8. The scanning unit 9 is positioned in the upper portion of the internal space of the casing 8. The scanning unit 9 has a scanning function. The printing unit 11 is positioned below the scanning unit 9 in the internal space of the casing 8. The printing unit 11 has a printing function. The printing unit 11 is configured to record images on sheets 12 of paper shown in FIG. 2 according to the inkjet recording method. As shown in FIG. 2, the printing unit 11 includes a feeding unit 15, a feed tray 20, a discharge tray 21, a conveying path 65, a conveying roller set 54, a recording unit 24, a discharge roller set 55, a platen 42, and an ink tank set 51. The multifunction peripheral 10 is an example of the liquid consuming device.

### <Feed Tray 20 and Discharge Tray 21>

As shown in FIG. 1, the multifunction peripheral 10 has the opening 13. The opening 13 is formed in the front surface of the multifunction peripheral 10. The opening 13 is positioned in the left-right center portion of the multifunction peripheral 10. Through user operations, the feed tray 20 is movable in the front-rear direction through the opening 13. As shown in FIG. 2, the feed tray 20 supports a plurality of sheets 12 in a stacked state. The discharge tray 21 is positioned above the feed tray 20. The discharge tray 21 is movable in the front-rear direction together with the feed tray 20. The discharge tray 21 supports sheets 12 discharged by the discharge roller set 55.

### <Feeding Unit 15>

The feeding unit 15 is configured to feed sheets 12 supported on the feed tray 20 onto the conveying path 65. As shown in FIG. 2, the feeding unit 15 includes a feed roller 25, a feed arm 26, and a shaft 27. The feed roller 25 is rotatably supported on the distal end of the feed arm 26. The feed roller 25 is configured to rotate in a direction for conveying sheets 12 in a conveying direction 16 by receiving a drive force transmitted from a conveying motor (not shown). Hereinafter, the feed roller 25 rotating in the direction for conveying sheets 12 in the conveying direction 16 will be expressed as “the feed roller 25 rotating forward.” The same applies to a conveying roller 60 (described below) and a discharge roller 62 (described below). The shaft 27 is supported by a frame of the printing unit 11. The feed arm 26 is rotatably supported by the shaft 27. The feed arm 26 is urged to rotate toward the feed tray 20 by its own weight or the elastic force of a spring or the like.

### <Conveying Path 65>

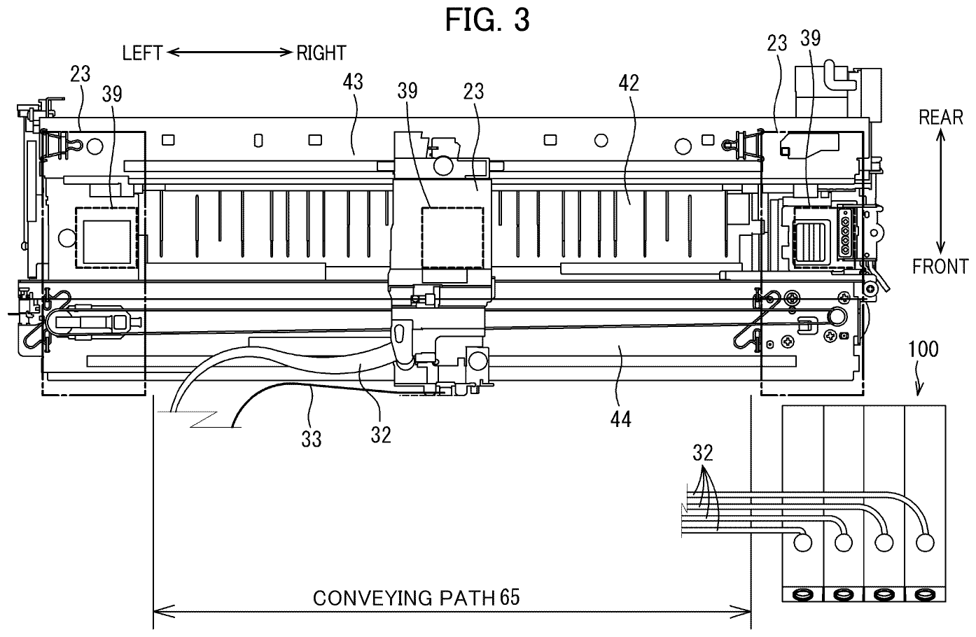

As shown in FIG. 2, the conveying path 65 denotes space defined by an outer guide member 18 and an inner guide member 19 that oppose each other with a prescribed interval therebetween, for example. The conveying path 65 extends from the rear side of the feed tray 20 toward the rear of the printing unit 11, extends upward in the rear of the printing unit 11 while making a U-turn, and passes through the space between the recording unit 24 and platen 42 to reach the discharge tray 21. As shown in FIGS. 2 and 3, the section of the conveying path 65 between the conveying roller set 54 and the discharge roller set 55 is positioned in the approximate left-right center of the multifunction peripheral 10 and extends in the front-rear direction. Arrows depicted with one-dot chain lines in FIG. 2 indicate the conveying direction 16 of sheets 12 on the conveying path 65.

### <Conveying Roller Set 54>

As shown in FIG. 2, the conveying roller set 54 is positioned upstream of the recording unit 24 in the conveying direction 16. The conveying roller set 54 includes the conveying roller 60 and a pinch roller 61. The conveying roller 60 and pinch roller 61 oppose each other in the up-down direction. The conveying roller 60 is configured to rotate by receiving a drive force transmitted from the conveying motor. The pinch roller 61 is configured to rotate in accordance with the rotation of the conveying roller 60. When the conveying roller 60 is driven to rotate forward by the forward rotation of the conveying motor, a sheet 12 nipped between the conveying roller 60 and pinch roller 61 is conveyed in the conveying direction 16.

### <Discharge Roller Set 55>

As shown in FIG. 2, the discharge roller set 55 is positioned downstream of the recording unit 24 in the conveying direction 16. The discharge roller set 55 includes the discharge roller 62 and spurs 63. The discharge roller 62 and spurs 63 oppose each other in the up-down direction. The discharge roller 62 is configured to rotate by receiving a drive force transmitted from the conveying motor. The spurs 63 are configured to rotate in accordance with the rotation of the discharge roller 62. When the discharge roller 62 is driven to rotate forward by the forward rotation of the conveying motor, a sheet 12 nipped between the discharge roller 62 and the spurs 63 is conveyed in the conveying direction 16.

### <Recording Unit 24>

As shown in FIG. 2, the recording unit 24 is positioned between the conveying roller set 54 and the discharge roller set 55 in the conveying direction 16. The recording unit 24 opposes the platen 42 in the up-down direction with the conveying path 65 interposed therebetween. The recording unit 24 is positioned upward relative to the conveying path 65 in the up-down direction. The recording unit 24 includes a carriage 23, and a recording head 39.

As shown in FIG. 3, the carriage 23 is supported on guide rails 43 and 44. The guide rails 43 and 44 are supported by the frame of the printing unit 11. The guide rails 43 and 44 are spaced apart from each other in the front-rear direction. Each of the guide rails 43 and 44 extends in the left-right direction. The carriage 23 is coupled to a well-known belt mechanism provided on the guide rail 44. The belt mechanism is configured to rotate by receiving a drive force transmitted from a carriage motor (not shown). When the belt mechanism rotates, the carriage 23 moves in the left-right direction. The one-dot chain lines in FIG. 3 indicate the moving range of the carriage 23. The carriage 23 moves in the left-right direction between positions on the right side and left side of the conveying path 65.

The recording head 39 is connected to an ink tank 100 (described later) by four ink tubes 32. The recording head 39 is electrically connected to a control board by a flexible flat cable 33. A control unit (not shown) is mounted on the control board. The ink tubes 32 and the flexible flat cable 33 both extend from the carriage 23. The ink tubes 32 are configured to supply ink stored in the ink tank 100 to the recording head 39. The flexible flat cable 33 is configured to transmit control signals outputted from the control unit to the recording head 39.

As shown in FIG. 2, the carriage 23 supports the recording head 39. In other words, the recording head 39 is mounted on the carriage 23. A plurality of nozzles 40 is formed in the bottom surface of the recording head 39. The recording head 39 is configured to eject ink from the nozzles 40 in the form of microdroplets. The recording head 39 is configured to record an image on a sheet 12 supported on the platen 42 by ejecting the ink droplets toward the sheet 12 as the carriage 23 moves.

### <Platen 42>

As shown in FIGS. 2 and 3, the platen 42 is positioned between the conveying roller set 54 and discharge roller set 55 in the conveying direction 16. The platen 42 opposes the recording unit 24 in the up-down direction. The platen 42 is configured to support the bottom of a sheet 12 being conveyed by the conveying roller set 54.

### <Ink Tank Set 51>

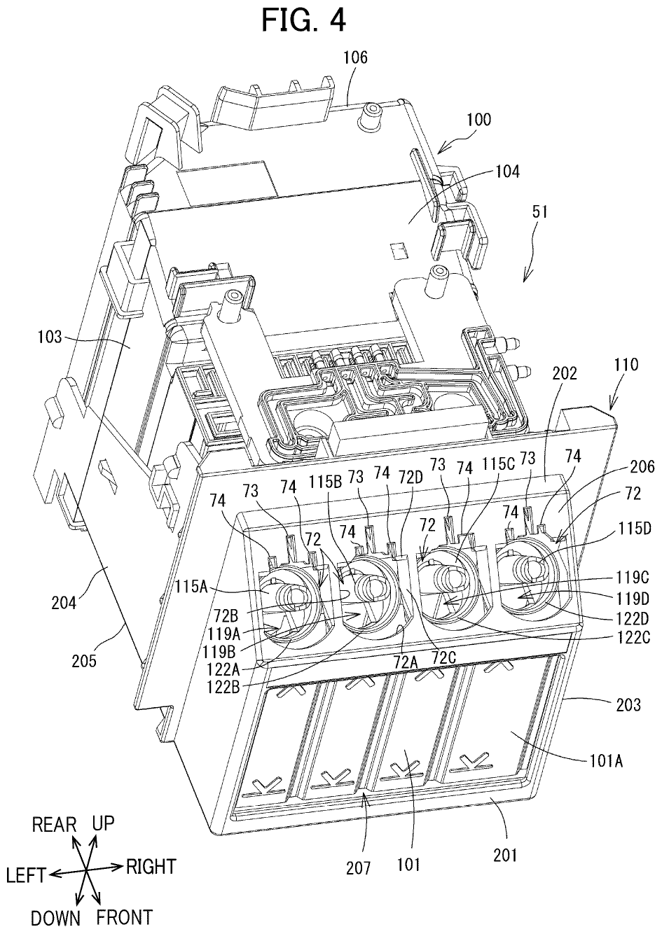

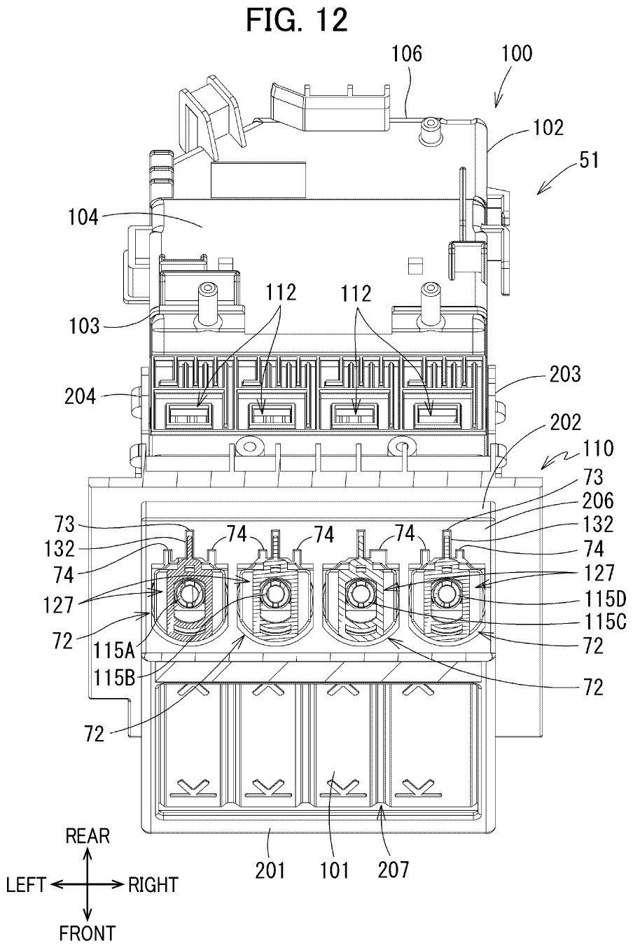

As shown in FIG. 4, the ink tank set 51 includes the ink tank 100, a tank cover 110, and four tank caps 127 (see FIG. 12). The ink tank 100 is an example of the tank. The tank caps 127 have been omitted from FIG. 4. As shown in FIG. 1, the ink tank set 51 is located inside the multifunction peripheral 10. The ink tank set 51 is fixed in the multifunction peripheral 10 so that a user cannot easily remove the ink tank set 51 from the multifunction peripheral 10. An opening is formed in the right end portion of the front surface of the casing 8. The ink tank set 51 is positioned to the rear of this opening.

A cover 70 is provided on the casing 8 over the front of the opening formed in the casing 8. The cover 70 is pivotable about a rotational axis extending in the left-right direction at the bottom end of the cover 70. The cover 70 is pivotable from a covering position (FIG. 1) in which the cover 70 covers the opening in the casing 8 to an exposing position in which the cover 70 exposes the opening in the casing 8 to the outside of the multifunction peripheral 10. In other words, the cover 70 is pivotable from the covering position (FIG. 1) in which the cover 70 covers the ink tank set 51 to the exposing position in which the cover 70 exposes the ink tank set 51 to the outside of the multifunction peripheral 10. The cover 70 has an opening. A portion of the ink tank set 51 is exposed to the outside of the multifunction peripheral 10 through the opening in the cover 70, even when the cover 70 is in the covering position. Here, a portion of the ink tank set 51 being exposed to the outside of the multifunction peripheral 10 through the opening in the cover 70 signifies that a user outside the multifunction peripheral 10 can see at least part of the ink tank set 51 through the opening in the cover 70 and does not signify that part of the ink tank set 51 protrudes outside the multifunction peripheral 10 through the opening in the cover 70.

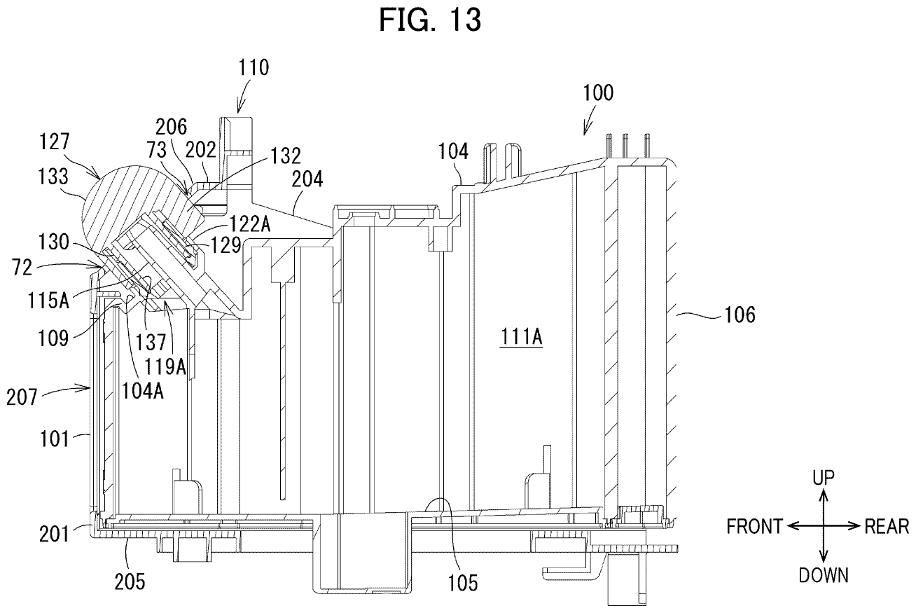

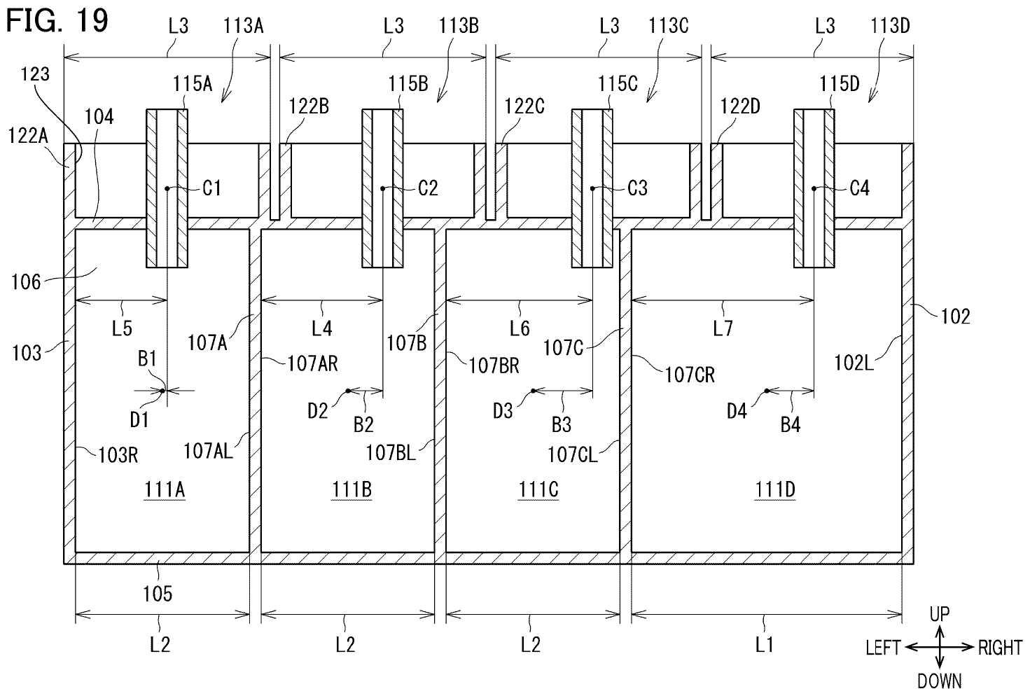

As shown in FIGS. 13 and 19, the ink tank 100 includes four ink chambers 111A, 111B, 111C, and 111D in the inside of the ink tank 100. The four ink chambers 111A, 111B, 111C, and 111D are juxtaposed in the left-right direction. The three ink chambers 111A, 111B, and 111C store ink in different colors. Specifically, the three ink chambers 111A, 111B, and 111C store ink in one of the colors yellow, cyan, and magenta. The ink chamber HID stores black ink. The ink is an example of the liquid. The left-right direction is an example of the first direction. The horizontal direction is also an example of the first direction.

As shown in FIGS. 4, 5 and 19, the ink tank 100 has a generally rectangular parallelepiped external shape. The ink tank 100 has a front wall 101, a right wall 102, a left wall 103, a top wall 104, a bottom wall 105, a rear wall 106, and three partition walls 107A, 107B, and 107C. The ink tank 100 is integrally formed as a single member by injection molding of a resin material, for example. Among the outer walls of the ink tank 100, the bottom wall 105 may be separately molded, for example. The front wall 101, right wall 102, left wall 103, top wall 104, bottom wall 105, and rear wall 106 are translucent to the degree that the levels of ink inside the ink tank 100 are visible from outside the ink tank 100. The front wall 101 has a front surface 101A. The right wall 102 has a left surface 102L. The left wall 103 has a right surface 103R. The front wall 101 is an example of the viewing wall.

The three partition walls 107A, 107B, and 107C are spaced at intervals in the left-right direction. Each of the partition walls 107A, 107B, and 107C has a flat plate shape extending in the front-rear and up-down directions. The front edges of the partition walls 107A, 107B, and 107C connect to the rear surface of the front wall 101. The rear edges of the partition walls 107A, 107B, and 107C connect to the front surface of the rear wall 106. The top edges of the partition walls 107A, 107B, and 107C connect to the bottom surface of the top wall 104. The bottom edges of the partition walls 107A, 107B, and 107C connect to the top surface of the bottom wall 105. The partition wall 107A has a left surface 107AL and a right surface 107AR. The partition wall 107B has a left surface 107BL and a right surface 107BR. The partition wall 107C has a left surface 107CL and a right surface 107CR.

The ink chamber 111A is defined by the partition wall 107A, front wall 101, left wall 103, top wall 104, bottom wall 105, and rear wall 106. The ink chamber 111B is defined by the partition wall 107A, partition wall 107B, front wall 101, top wall 104, bottom wall 105, and rear wall 106. The ink chamber 111C is defined by the partition wall 107B, partition wall 107C, front wall 101, top wall 104, bottom wall 105, and rear wall 106. The ink chamber 111D is defined by the partition wall 107C, front wall 101, right wall 102, top wall 104, bottom wall 105, and rear wall 106.

The left-right length L1 of the ink chamber 111D is greater than the left-right length L2 of the ink chamber 111C. The ink chamber 111D has a higher capacity than the ink chamber 111C. The left-right length L1 is the distance between the right surface 107CR of the partition wall 107C and the left surface 102L of the right wall 102 in the left-right direction. The left-right length L2 is the distance between the right surface 107BR of the partition wall 107B and the left surface 107CL of the partition wall 107C in the left-right direction. The left-right length of each of the ink chambers 111A and 111B is equivalent to the left-right length L2. In other words, the left-right length L2 is also the distance between the right surface 107AR of the partition wall 107A and the left surface 107BL of the partition wall 107B in the left-right direction and the distance between the right surface 103R of the left wall 103 and the left surface 107AL of the partition wall 107A in the left-right direction. The ink chamber 111D is an example of the second storage chamber. The ink chamber 111C is an example of the first storage chamber. The right surface 107CR is an example of the first surface.

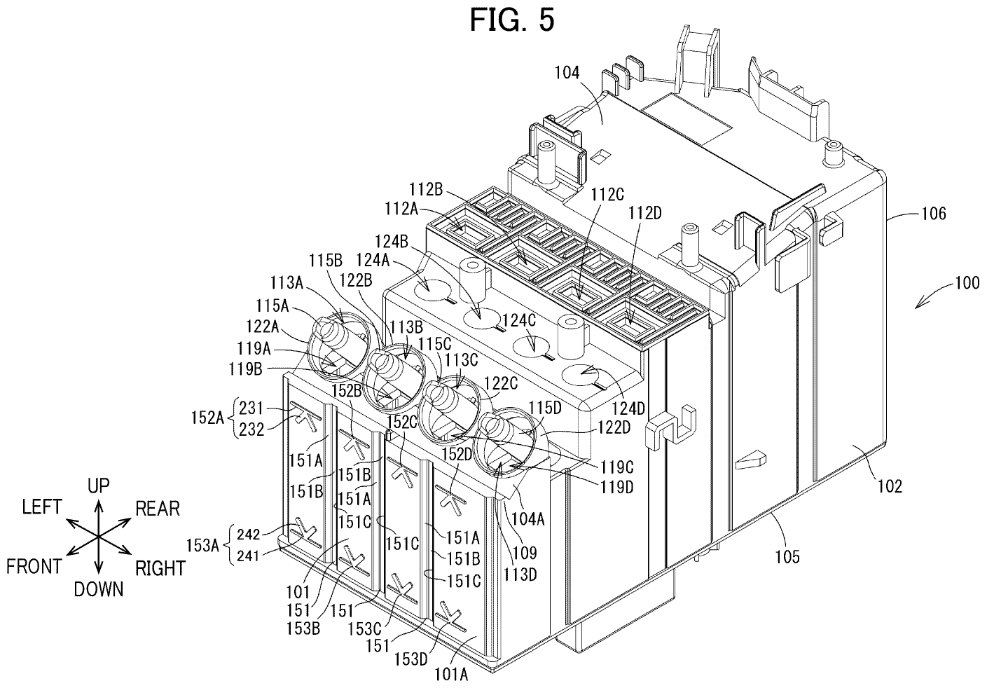

As shown in FIG. 5, the front surface 101A of the front wall 101 has three recessed surfaces 151 that are recessed rearward. The three recessed surfaces 151 are spaced at intervals in the left-right direction. Each recessed surface 151 extends from the top edge to the bottom edge of the front wall 101. The left-right positions of the recessed surfaces 151 is aligned with the left-right positions of the corresponding partition walls 107A, 107B, and 107C. Each recessed surface 151 has a left sloped surface 151A, a middle surface 151B, and a right sloped surface 151C. The left sloped surface 151A slopes relative to the left-right direction so as to extend rearward toward the right. The middle surface 151B is connected to the rear edge of the left sloped surface 151A. The middle surface 151B faces forward and extends in the left-right and up-down directions. The right sloped surface 151C is connected to the right edge of the middle surface 151B. The right sloped surface 151C slopes relative to the left-right direction so as to extend forward toward the right.

Four upper marks 152A, 152B, 152C, and 152D and four lower marks 153A, 153B, 153C, and 153D are arranged on the front surface 101A of the front wall 101. The four upper marks 152A, 152B, 152C, and 152D are spaced at intervals in the left-right direction. The upper marks 152A, 152B, 152C, and 152D are located at the top portion of the front surface 101A. Each of the upper marks 152A, 152B, 152C, and 152D has a top line 231 extending in the left-right direction, and an up arrow 232 positioned beneath the top line 231. The tip of the up arrow 232 is positioned in the left-right center of the top line 231. Each of the lower marks 153A, 153B, 153C, and 153D has a bottom line 241 extending in the left-right direction, and a down arrow 242 positioned above the bottom line 241. The tip of the down arrow 242 is positioned in the left-right center of the bottom line 241. The four lower marks 153A, 153B, 153C, and 153D are spaced at intervals in the left-right direction. The lower marks 153A, 153B, 153C, and 153D are located at the bottom portion of the front surface 101A.

The left-right positions of the upper mark 152A and lower mark 153A are aligned with the ink chamber 111A. The left-right centers of the upper mark 152A and lower mark 153A are aligned with the left-right center D1 (see FIG. 19) of the ink chamber 111A. The upper mark 152A indicates that the ink chamber 111A is full of ink when the ink level is at the position of the top line 231. The lower mark 153A indicates that the ink chamber 111A needs to be replenished with ink when the ink level is at the position of the bottom line 241.

The left-right positions of the upper mark 152B and lower mark 153B are aligned with the ink chamber 111B. The left-right centers of the upper mark 152B and lower mark 153B are aligned with the left-right center D2 of the ink chamber 111B. The upper mark 152B indicates that the ink chamber 111B is full of ink when the ink level is at the position of the top line 231. The lower mark 153B indicates that the ink chamber 111B needs to be replenished with ink when the ink level is at the position of the bottom line 241.

The left-right positions of the upper mark 152C and lower mark 153C are aligned with the ink chamber 111C. The left-right centers of the upper mark 152C and lower mark 153C are aligned with the left-right center D3 of the ink chamber 111C. The upper mark 152C indicates that the ink chamber 111C is full of ink when the ink level is at the position of the top line 231. The lower mark 153C indicates that the ink chamber 111C needs to be replenished with ink when the ink level is at the position of the bottom line 241. The upper mark 152C is an example of the mark. The lower mark 153C is an example of the mark.

The left-right positions of the upper mark 152D and lower mark 153D are aligned with the ink chamber 111D. The left-right centers of the upper mark 152D and lower mark 153D are positioned leftward relative to the left-right center D4 of the ink chamber 111D. The upper mark 152D indicates that the ink chamber 111D is full of ink when the ink level is at the position of the top line 231. The lower mark 153D indicates that the ink chamber 111D needs to be replenished with ink when the ink level is at the position of the bottom line 241.

The top surface of the top wall 104 is configured of a plurality of surfaces, each of which extends in the front-rear and left-right directions. The top wall 104 has four atmospheric communication ports 112A, 112B, 112C, and 112D. The four atmospheric communication ports 112A, 112B, 112C, and 112D are spaced at equal intervals in the left-right direction. Each of the atmospheric communication ports 112A, 112B, 112C, and 112D penetrates the top wall 104 in the up-down direction. Each of the atmospheric communication ports 112A, 112B, 112C, and 112D has a rectangular shape that is elongated in the left-right direction. The atmospheric communication port 112A provides communication between the interior of the ink chamber 111A and the exterior of the ink chamber 111A. More specifically, in the present embodiment, the atmospheric communication port 112A provides communication between the interior of the ink chamber 111A and the exterior of the ink tank 100. The atmospheric communication port 112B provides communication between the interior of the ink chamber 111B and the exterior of the ink chamber 111B. More specifically, in the present embodiment, the atmospheric communication port 112B provides communication between the interior of the ink chamber 111B and the exterior of the ink tank 100. The atmospheric communication port 112C provides communication between the interior of the ink chamber 111C and the exterior of the ink chamber 111C. More specifically, in the present embodiment, the atmospheric communication port 112C provides communication between the interior of the ink chamber 111C and the exterior of the ink tank 100. The atmospheric communication port 112D provides communication between the interior of the ink chamber 111D and the exterior of the ink chamber 111D. More specifically, in the present embodiment, the atmospheric communication port 112D provides communication between the interior of the ink chamber 111D and the exterior of the ink tank 100.

The top surface of the top wall 104 further has a sloped surface 104A. The sloped surface 104A is positioned at the front end portion of the top surface of the top wall 104. The sloped surface 104A slopes relative to the front-rear direction so as to extend downward toward the front. The sloped surface 104A extends between the left edge and right edge of the ink tank 100. As shown in FIGS. 5 and 13, a barrier wall 109 is located on the front edge of the sloped surface 104A. The barrier wall 109 protrudes diagonally upward and forward from the sloped surface 104A. The barrier wall 109 extends in the left-right direction between the left edge and right edge of the ink tank 100.

Four outflow tubes 124A, 124B, 124C, and 124D are positioned in the top wall 104. The four outflow tubes 124A, 124B, 124C, and 124D are spaced at equal intervals in the left-right direction. The outflow tube 124A is a circular tube that extends downward from the top wall 104 to the interior of the ink chamber 111A. The outflow tube 124B is a circular tube that extends downward from the top wall 104 to the interior of the ink chamber 111B. The outflow tube 124C is a circular tube that extends downward from the top wall 104 to the interior of the ink chamber 111C. The outflow tube 124D is a circular tube that extends downward from the top wall 104 to the interior of the ink chamber 111D. The bottom ends of the outflow tubes 124A, 124B, 124C, and 124D are positioned near the bottom wall 105. The openings in the top ends of the outflow tubes 124A, 124B, 124C, and 124D are located in the top wall 104.

Each of the ink tubes 32 is configured to be connected to the top end of a corresponding one of the outflow tubes 124A, 124B, 124C, and 124D. Ink in the ink chambers 111A, 111B, 111C, and 111D flows to the recording head 39 through the corresponding outflow tubes 124A, 124B, 124C, and 124D and ink tubes 32. As ink in each of the ink chambers 111A, 111B, 111C, and 111D is consumed by ink being ejected from the recording head 39 during printing, air flows into the ink chambers 111A, 111B, 111C, and 111D through the respective atmospheric communication ports 112A, 112B, 112C, and 112D.

As shown in FIGS. 5 and 19, four communication parts 113A, 113B, 113C, and 113D are positioned in the front end portion of the top wall 104. The four communication parts 113A, 113B, 113C, and 113D are spaced at equal intervals in the left-right direction. Each of the communication parts 113A, 113B, 113C, and 113D is a part to which a liquid bottle 80 described later is configured to be connected. The communication part 113A includes an annular wall 122A and a tank tube 115A, and has a communication opening 119A. The communication part 113B includes an annular wall 122B and a tank tube 115B, and has a communication opening 119B. The communication part 113C includes an annular wall 122C and a tank tube 115C, and has a communication opening 119C. The communication part 113D includes an annular wall 122D and a tank tube 115D, and has a communication opening 119D. The communication part 113C is an example of the first communication part. The communication part 113D is an example of the second communication part.

The four annular walls 122A, 122B, 122C, and 122D are spaced at equal intervals in the left-right direction. Each of the annular walls 122A, 122B, 122C, and 122D has a cylindrical shape that extends diagonally upward and forward from the front end portion of the top wall 104 along an extension direction that crosses both the direction of gravity and the horizontal direction. Note that FIG. 19 shows the annular walls 122A, 122B, 122C, and 122D extending upward for simplification. Each of the annular walls 122A, 122B, 122C, and 122D has the same outer diameter L3 and the same inner diameter. The outer diameter L3 of each of the annular walls 122A, 122B, 122C, and 122D is greater than the left-right length L2 of the ink chamber 111C. The inner diameter of each of the annular walls 122A, 122B, 122C, and 122D is also greater than the left-right length L2 of the ink chamber 111C.

The annular wall 122A is positioned above the ink chamber 111A. The left-right position of the left end of the annular wall 122A is aligned with the left-right position of the left wall 103. The right end of the annular wall 122A is positioned slightly rightward relative to the partition wall 107A in the left-right direction. Consequently, the left-right position of a portion of the annular wall 122A is aligned with the left-right position of the ink chamber 111B (a portion of the annular wall 122A and a portion of the ink chamber 111B are at the same position in the left-right direction). In other words, the annular wall 122A is positioned to span between the ink chamber 111A and the ink chamber 111B in the left-right direction. The left-right center C1 of the annular wall 122A is offset slightly rightward from the left-right center D1 of the ink chamber 111A.

The annular wall 122B is positioned above the ink chamber 111B. The left-right position of the left end of the annular wall 122B is aligned with the left-right position of the ink chamber 111B. The right end of the annular wall 122B is positioned rightward relative to the partition wall 107B. Accordingly, the left-right position of a portion of the annular wall 122B is aligned with the left-right position of the ink chamber 111C (a portion of the annular wall 122B and a portion of the ink chamber 111C are at the same position in the left-right direction). In other words, the annular wall 122B is positioned to span between the ink chamber 111B and the ink chamber 111C in the left-right direction. The left-right center C2 of the annular wall 122B is offset rightward from the left-right center D2 of the ink chamber 111B. The offset amount B2 by which the left-right center C2 of the annular wall 122B is offset from the left-right center D2 of the ink chamber 111B is larger than the offset amount B1 by which the left-right center C1 of the annular wall 122A is offset from the left-right center D1 of the ink chamber 111A. The distance L4 in the left-right direction between the left-right center C2 of the annular wall 122B and the right surface 107AR of the partition wall 107A is greater than the distance L5 in the left-right direction between the right surface 103R of the left wall 103 and the left-right center C1 of the annular wall 122A.

The annular wall 122C is positioned above the ink chamber 111C. The left-right position of the left end of the annular wall 122C is aligned with the left-right position of the ink chamber 111C. The right end of the annular wall 122C is positioned significantly rightward relative to the partition wall 107C. As a result, the left-right position of a portion of the annular wall 122C is aligned with the left-right position of the ink chamber 111D (i.e., a portion of the annular wall 122C and a portion of the ink chamber 111D are at the same position in the left-right direction). That is, a portion of the annular wall 122C is located at a position overlapping a portion of the ink chamber 111D as viewed in the up-down direction. In other words, the annular wall 122C is positioned to span between the ink chamber 111C and the ink chamber 111D in the left-right direction. The offset amount B3 by which the left-right center C3 of the annular wall 122C is offset from the left-right center D3 of the ink chamber 111C is larger than the offset amount B2 by which the left-right center C2 of the annular wall 122B is offset from the left-right center D2 of the ink chamber 111B. The manner in which the left-right center C2 of the annular wall 122B is offset from the left-right center D2 of the ink chamber 111B is different from the manner in which the left-right center C3 of the annular wall 122C is offset from the left-right center D3 of the ink chamber 111C. More specifically, the offset of the left-right center C2 of the annular wall 122B relative to the left-right center D2 of the ink chamber 111B and the offset of the left-right center C3 of the annular wall 122C relative to the left-right center D3 of the ink chamber 111C are different from each other in the direction from the ink chamber 111B toward the ink chamber 111C along the left-right direction (i.e., in the rightward direction). The distance L6 in the left-right direction between the left-right center C3 of the annular wall 122C and the right surface 107BR of the partition wall 107B is greater than the distance L4. The annular wall 122C is an example of the first tubular wall. The left surface 107CL is an example of the second surface.

The annular wall 122D is positioned above the ink chamber 111D. The left-right position of the left end of the annular wall 122D is aligned with the left-right position of the ink chamber 111D. The left-right position of the right end of the annular wall 122D is aligned with the left-right position of the right wall 102. The left-right center C4 of the annular wall 122D is offset significantly rightward from the left-right center D4 of the ink chamber 111D. The offset amount B4 by which the left-right center C4 of the annular wall 122D is offset from the left-right center D4 of the ink chamber 111D is smaller than the offset amount B3 and larger than the offset amount B2. The manner in which the left-right center C3 of the annular wall 122C is offset from the left-right center D3 of the ink chamber 111C is different from the manner in which the left-right center C4 of the annular wall 122D is offset from the left-right center D4 of the ink chamber 111D. More specifically, the offset of the left-right center C3 of the annular wall 122C relative to the left-right center D3 of the ink chamber 111C and the offset of the left-right center C4 of the annular wall 122D relative to the left-right center D4 of the ink chamber 111D are different from each other in the direction from the ink chamber 111C toward the ink chamber 111D along the left-right direction (i.e., in the rightward direction). The distance L7 in the left-right direction between the left-right center C4 of the annular wall 122D and the right surface 107CR of the partition wall 107C is greater than the distance L6. The annular wall 122D is an example of the second tubular wall.

Note that the left-right center of the communication part 113A is aligned with the left-right center C1 of the annular wall 122A, the left-right center of the communication part 113B is aligned with the left-right center C2 of the annular wall 122B, the left-right center of the communication part 113C is aligned with the left-right center C3 of the annular wall 122C, and the left-right center of the communication part 113D is aligned with the left-right center C4 of the annular wall 122D. Accordingly, the manner in which the left-right center of the communication part 113C is offset from the left-right center D3 of the ink chamber 111C is different from the manner in which the left-right center of the communication part 113D is offset from the left-right center D4 of the ink chamber 111D.

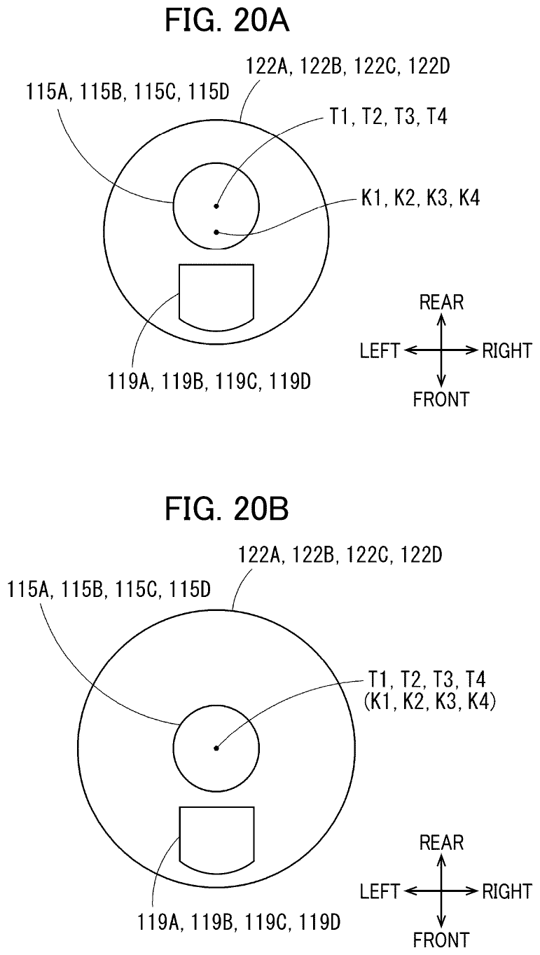

The tank tube 115A is positioned inward of the annular wall 122A. The tank tube 115A is surrounded by the annular wall 122A. The tank tube 115A is a circular tube that extends diagonally upward and forward from the top surface of the top wall 104. The tank tube 115A extends parallel to the annular wall 122A along the extension direction that crosses the direction of gravity and the horizontal direction. The tank tube 115A protrudes further upward than the top of the annular wall 122A. The top end of the tank tube 115A is open to the exterior of the ink chamber 111A. The bottom end of the tank tube 115A is open inside the ink chamber 111A. The interior space of the tank tube 115A provides communication between the exterior and interior of the ink chamber 111A. The top end portion of the tank tube 115A is divided in the left-right direction into two lip portions. The left-right center of the tank tube 115A is aligned with the left-right center C1 of the annular wall 122A. As shown in FIG. 20A, the tank tube 115A has a circular cross section with the center T1, and the annular wall 122A has a circular cross section with the center K1. That is, the tank tube 115A has an opening whose center is the center T1, and the annular wall 122A has an opening whose center is the center K1. The center T1 of the tank tube 115A is positioned farther rearward than the center K1 of the annular wall 122A. In other words, the center axis of the tank tube 115A is positioned rearward relative to the center axis of the annular wall 122A when viewed in the extension direction of the tank tube 115A. The center axis of the tank tube 115A passes through the center of the tank tube 115A and the center axis of the annular wall 122A passes through the center of the annular wall 122A.

The communication opening 119A is positioned inward of the annular wall 122A. The communication opening 119A is located in the sloped surface 104A. The communication opening 119A is surrounded by the annular wall 122A. The communication opening 119A penetrates the top wall 104 in the up-down direction. The communication opening 119A is circular on the front side and rectangular on the rear side. In other words, the communication opening 119A has a quadrilateral shape with the front side expanding forward in an arc shape. The communication opening 119A provides communication between the exterior and interior of the ink chamber 111A. The left-right center of the communication opening 119A is aligned with the left-right center C1 of the annular wall 122A. As shown in FIG. 13, the communication opening 119A is positioned forward of the tank tube 115A. The communication opening 119A is located lower than the tank tube 115A. In other words, a straight line that extends along the extension direction of the tank tube 115A and passes through the center of the communication opening 119A when viewed in the extension direction of the tank tube 115A is positioned forward of the center axis passing through the center of the tank tube 115A when viewed in the extension direction of the tank tube 115A. As shown in FIG. 20A, the communication opening 119A is positioned farther forward than the center K1 of the annular wall 122A. In other words, a straight line extending along the extension direction of the annular wall 122A and passing through the center of the communication opening 119A when viewed in the extension direction of the annular wall 122A is positioned forward of the center axis passing through the center of the annular wall 122A when viewed in the extension direction of the annular wall 122A.

The tank tube 115B is positioned inward of the annular wall 122B. The tank tube 115B is surrounded by the annular wall 122B. The tank tube 115B is a circular tube that extends diagonally upward and forward from the top surface of the top wall 104. The tank tube 115B extends parallel to the annular wall 122B along the extension direction that crosses the direction of gravity and the horizontal direction. The tank tube 115B protrudes further upward than the top of the annular wall 122B. The top end of the tank tube 115B is open to the exterior of the ink chamber 111B. The bottom end of the tank tube 115B is open inside the ink chamber 111B. The interior space of the tank tube 115B provides communication between the exterior and interior of the ink chamber 111B. The top end portion of the tank tube 115B is divided in the left-right direction into two lip portions. The left-right center of the tank tube 115B is aligned with the left-right center C2 of the annular wall 122B. As shown in FIG. 20A, the tank tube 115B has a circular cross section with the center T2, and the annular wall 122B has a circular cross section with the center K2. That is, the tank tube 115B has an opening whose center is the center T2, and the annular wall 122B has an opening whose center is the center K2. The center T2 of the tank tube 115B is positioned farther rearward than the center K2 of the annular wall 122B. In other words, the center axis of the tank tube 115B is positioned rearward of the center axis of the annular wall 122B when viewed in the extension direction of the tank tube 115B. The center axis of the tank tube 115B passes through the center of the tank tube 115B and the center axis of the annular wall 122B passes through the center of the annular wall 122B.

As shown in FIG. 5, the communication opening 119B is positioned inward of the annular wall 122B. The communication opening 119B is located in the sloped surface 104A. The communication opening 119B is surrounded by the annular wall 122B. The communication opening 119B penetrates the top wall 104 in the up-down direction. The communication opening 119B is circular on the front side and rectangular on the rear side. In other words, the communication opening 119B has a quadrilateral shape with the front side expanding forward in an arc shape. The communication opening 119B provides communication between the exterior and interior of the ink chamber 111B. The left-right center of the communication opening 119B is aligned with the left-right center C2 of the annular wall 122B. As shown in FIG. 13, the communication opening 119B is positioned forward of the tank tube 115B. The communication opening 119B is located lower than the tank tube 115B. In other words, a straight line that extends along the extension direction of the tank tube 115B and passes through the center of the communication opening 119B when viewed in the extension direction of the tank tube 115B is positioned forward of the center axis passing through the center of the tank tube 115B when viewed in the extension direction of the tank tube 115B. As shown in FIG. 20A, the communication opening 119B is positioned farther forward than the center K2 of the annular wall 122B. In other words, a straight line extending along the extension direction of the annular wall 122B and passing through the center of the communication opening 119B when viewed in the extension direction of the annular wall 122B is positioned forward of the center axis passing through the center of the annular wall 122B when viewed in the extension direction of the annular wall 122B.

The tank tube 115C is positioned inward of the annular wall 122C. The tank tube 115C is surrounded by the annular wall 122C. The tank tube 115C is a circular tube that extends diagonally upward and forward from the top surface of the top wall 104. The tank tube 115C extends parallel to the annular wall 122C along the extension direction that crosses the direction of gravity and the horizontal direction. The tank tube 115C protrudes further upward than the top of the annular wall 122C. The top end of the tank tube 115C is open to the exterior of the ink chamber 111C. The bottom end of the tank tube 115C is open inside the ink chamber 111C. The interior space of the tank tube 115C provides communication between the exterior and interior of the ink chamber 111C. The top end portion of the tank tube 115C is divided in the left-right direction into two lip portions. The left-right center of the tank tube 115C is aligned with the left-right center C3 of the annular wall 122C. As shown in FIG. 20A, the tank tube 115C has a circular cross section with the center T3, and the annular wall 122C has a circular cross section with the center K3. That is, the tank tube 115C has an opening whose center is the center T3, and the annular wall 122C has an opening whose center is the center K3. The center T3 of the tank tube 115C is positioned farther rearward than the center K3 of the annular wall 122C. In other words, the center axis of the tank tube 115C is positioned rearward of the center axis of the annular wall 122C when viewed in the extension direction of the tank tube 115C. The center axis of the tank tube 115C passes through the center of the tank tube 115C and the center axis of the annular wall 122C passes through the center of the annular wall 122C. The tank tube 115C is an example of the first nozzle.

As shown in FIG. 5, the communication opening 119C is positioned inward of the annular wall 122C. The communication opening 119C is located in the sloped surface 104A. The communication opening 119C is surrounded by the annular wall 122C. The communication opening 119C penetrates the top wall 104 in the up-down direction. The communication opening 119C is circular on the front side and rectangular on the rear side. In other words, the communication opening 119C has a quadrilateral shape with the front side expanding forward in an arc shape. The communication opening 119C provides communication between the exterior and interior of the ink chamber 111C. The left-right center of the communication opening 119C is aligned with the left-right center C3 of the annular wall 122C. As shown in FIG. 13, the communication opening 119C is positioned forward of the tank tube 115C. The communication opening 119C is located lower than the tank tube 115C. In other words, a straight line that extends along the extension direction of the tank tube 115C and passes through the center of the communication opening 119C when viewed in the extension direction of the tank tube 115C is positioned forward of the center axis passing through the center of the tank tube 115C when viewed in the extension direction of the tank tube 115C. As shown in FIG. 20A, the communication opening 119C is positioned farther forward than the center K3 of the annular wall 122C. In other words, a straight line extending along the extension direction of the annular wall 122C and passing through the center of the communication opening 119C when viewed in the extension direction of the annular wall 122C is positioned forward of the center axis passing through the center of the annular wall 122C when viewed in the extension direction of the annular wall 122C. The communication opening 119C is an example of the first injection port.

The tank tube 115D is positioned inward of the annular wall 122D. The tank tube 115D is surrounded by the annular wall 122D. The tank tube 115D is a circular tube that extends diagonally upward and forward from the top surface of the top wall 104. The tank tube 115D extends parallel to the annular wall 122D along the extension direction that crosses the direction of gravity and the horizontal direction. The tank tube 115D protrudes further upward than the top of the annular wall 122D. The top end of the tank tube 115D is open to the exterior of the ink chamber 111D. The bottom end of the tank tube 115D is open inside the ink chamber 111D. The interior space of the tank tube 115D provides communication between the exterior and interior of the ink chamber 111D. The top end portion of the tank tube 115D is divided in the left-right direction into two lip portions. The left-right center of the tank tube 115D is aligned with the left-right center C4 of the annular wall 122D. As shown in FIG. 20A, the tank tube 115D has a circular cross section with the center T4, and the annular wall 122D has a circular cross section with the center K4. That is, the tank tube 115D has an opening whose center is the center T4, and the annular wall 122D has an opening whose center is the center K4. The center T4 of the tank tube 115D is positioned farther rearward than the center K4 of the annular wall 122D. In other words, the center axis of the tank tube 115D is positioned rearward of the center axis of the annular wall 122D when viewed in the extension direction of the tank tube 115D. The center axis of the tank tube 115D passes through the center of the tank tube 115D and the center axis of the annular wall 122D passes through the center of the annular wall 122D. The tank tube 115D is an example of the second nozzle.

As shown in FIG. 5, the communication opening 119D is positioned inward of the annular wall 122D. The communication opening 119D is located in the sloped surface 104A. The communication opening 119D is surrounded by the annular wall 122D. The communication opening 119D penetrates the top wall 104 in the up-down direction. The communication opening 119D is circular on the front side and rectangular on the rear side. In other words, the communication opening 119D has a quadrilateral shape with the front side expanding forward in an arc shape. The communication opening 119D provides communication between the exterior and interior of the ink chamber 111D. The left-right center of the communication opening 119D is aligned with the left-right center C4 of the annular wall 122D. As shown in FIG. 13, the communication opening 119D is positioned forward of the tank tube 115D. The communication opening 119D is located lower than the tank tube 115D. In other words, a straight line that extends along the extension direction of the tank tube 115D and passes through the center of the communication opening 119D when viewed in the extension direction of the tank tube 115D is positioned forward of the center axis passing through the center of the tank tube 115D when viewed in the extension direction of the tank tube 115D. As shown in FIG. 20A, the communication opening 119D is positioned farther forward than the center K4 of the annular wall 122D. In other words, a straight line extending along the extension direction of the annular wall 122D and passing through the center of the communication opening 119D when viewed in the extension direction of the annular wall 122D is positioned forward of the center axis passing through the center of the annular wall 122D when viewed in the extension direction of the annular wall 122D. The communication opening 119D is an example of the second injection port.

As shown in FIG. 4, the tank cover 110 holds the ink tank 100 and covers the front side of the ink tank 100 from the front. The tank cover 110 includes a front wall 201, a top wall 202, a right wall 203, a left wall 204, a bottom wall 205, and a sloped wall 206. The front wall 201 covers the front of the ink tank 100. The front wall 201 has an opening 207. A portion of the front wall 101 of the ink tank 100 is exposed to the front of the tank cover 110 through the opening 207. Here, a portion of the front wall 101 of the ink tank 100 being exposed to the front of the tank cover 110 through the opening 207 signifies that a user can see at least a portion of the front wall 101 from the front side of the tank cover 110 through the opening 207 and does not signify that a portion of the front wall 101 protrudes forward from the tank cover 110 through the opening 207.

The top wall 202 covers a portion of the front portion of the top wall 104 of the ink tank 100. The right wall 203 covers a portion of the right wall 102 of the ink tank 100. The left wall 204 covers a portion of the left wall 103 of the ink tank 100. The bottom wall 205 covers the bottom wall 105 of the ink tank 100.

The sloped wall 206 is connected to the top edge of the front wall 201 and is connected to the front edge of the top wall 202. The sloped wall 206 is positioned above the four annular walls 122A, 122B, 122C, and 122D of the ink tank 100. The sloped wall 206 is positioned forward of the four annular walls 122A, 122B, 122C, and 122D of the ink tank 100. In other words, the sloped wall 206 is positioned further in the extension direction, in which the annular walls 122A, 122B, 122C, and 122D extend from the front end portion of the top wall 104, relative to the annular walls 122A, 122B, 122C, and 122D. The outer surface of the sloped wall 206 crosses the direction of gravity and the horizontal direction. The outer surface of the sloped wall 206 slopes relative to the front-rear direction so as to extend downward toward the front. The sloped wall 206 covers a portion of the sloped surface 104A on the top wall 104 of the ink tank 100.

The sloped wall 206 has four through-holes 72 arranged at intervals in the left-right direction. Each through-hole 72 penetrates the sloped wall 206 in the up-down direction. In other words, the sloped wall 206 has four inner peripheral surfaces defining the four through-holes 72. Hereinafter, the inner peripheral surface defining the through-hole 72 will be called the “inner peripheral surface of the through-hole 72”. Each of the inner peripheral surfaces of the through-holes 72 has a tubular shape extending in a direction orthogonal to the outer surface of the sloped wall 206, i.e., diagonally upward and forward. In other words, each through-hole 72 has a tubular shape. Here, a tubular shape denotes the shape of an inner peripheral surface that surrounds an area to form an enclosed space. Thus, the shape of an opening defined by the inner peripheral surface does not necessarily have a circular shape. Further, the inner peripheral surface is regarded as having a tubular shape regardless of the length in which the inner peripheral surface extends in a direction in which the opening defined by that inner peripheral surface faces, i.e., regardless of the thickness of that through-hole 72. Each of the four through-holes 72 is formed in a position corresponding to a respective one of the four ink chambers 111A, 111B, 111C, and 111D. The inner peripheral surface of each through-hole 72 surrounds a corresponding one of the four annular walls 122A, 122B, 122C, and 122D when viewed from an upward and forward diagonal perspective. That is, each of the four through-holes 72 overlaps the corresponding one of the four ink chambers 111A, 111B, 111C, and 111D when viewed from an upward and forward diagonal perspective. The annular walls 122A, 122B, 122C, and 122D and the communication openings 119A, 119B, 119C, and 119D are exposed outside the tank cover 110 through the corresponding through-holes 72. Each of the tank tubes 115A, 115B, 115C, and 115D protrudes outside the tank cover 110 through the corresponding through-hole 72.

Each through-hole 72 is circular on the front side and rectangular on the rear side. In other words, the through-hole 72 has a quadrilateral shape with the front side expanding into an arc shape. Specifically, the inner peripheral surface of the through-hole 72 has an inner curved surface 72A that expands diagonally downward and forward, an inner left flat surface 72B connected to the left edge of the inner curved surface 72A, an inner right flat surface 72C connected to the right edge of the inner curved surface 72A, and an inner rear flat surface 72D connected to the rear edges of the inner left flat surface 72B and inner right flat surface 72C. The inner curved surface 72A constitutes the bottom of the inner peripheral surface of the through-hole 72. The inner rear flat surface 72D has a left-right center portion that expands diagonally upward and rearward.

A slit 73 extends rearward from the inner rear flat surface 72D of each through-hole 72. The slit 73 is positioned in the left-right center of the through-hole 72 and forms a continuous space with the through-hole 72.

As shown in FIGS. 4 and 12, one or more keyways 74 are selectively formed along the inner rear flat surface 72D of the inner peripheral surface of each through-hole 72 at positions to the left and right of the slit 73. The one or more keyways 74 form a continuous space with the corresponding through-hole 72 and extend rearward from the inner rear flat surface 72D of the corresponding through-hole 72. The presence, positions, and shapes of the keyways 74 differ for each through-hole 72. Specifically, for the leftmost through-hole 72 in FIGS. 4 and 12, one keyway 74 is positioned to the right of the slit 73 and one keyway 74 to the left of the slit 73. The distance in the left-right direction between the right keyway 74 and the slit 73 is equivalent to the distance in the left-right direction between the left keyway 74 and the slit 73.

For the through-hole 72 positioned second from the left in FIGS. 4 and 12, one keyway 74 is positioned to the right of the slit 73 and one keyway 74 to the left of the slit 73. The distance in the left-right direction between the right keyway 74 and the slit 73 is greater than the distance in the left-right direction between the left keyway 74 and the slit 73.

For the through-hole 72 positioned third from the left in FIGS. 4 and 12, one keyway 74 is positioned to the right of the slit 73 and none are positioned to the left of the slit 73. The left-right dimension of this right keyway 74 is greater than the left-right dimension of the keyways 74 for the through-hole 72 positioned second from the left.

For the rightmost through-hole 72 in FIGS. 4 and 12, one keyway 74 is positioned to the right of the slit 73 and one keyway 74 to the left of the slit 73. The distance in the left-right direction between the right keyway 74 and the slit 73 is shorter than the distance in the left-right direction between the left keyway 74 and the slit 73.

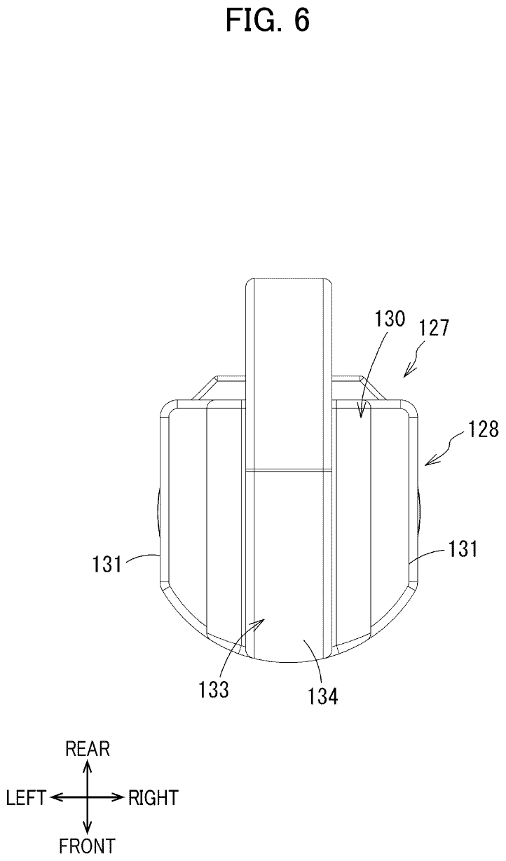

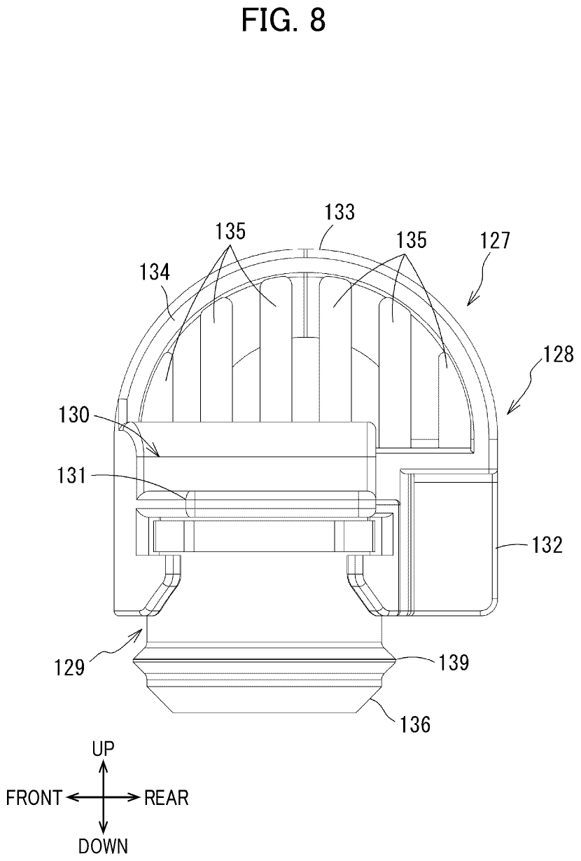

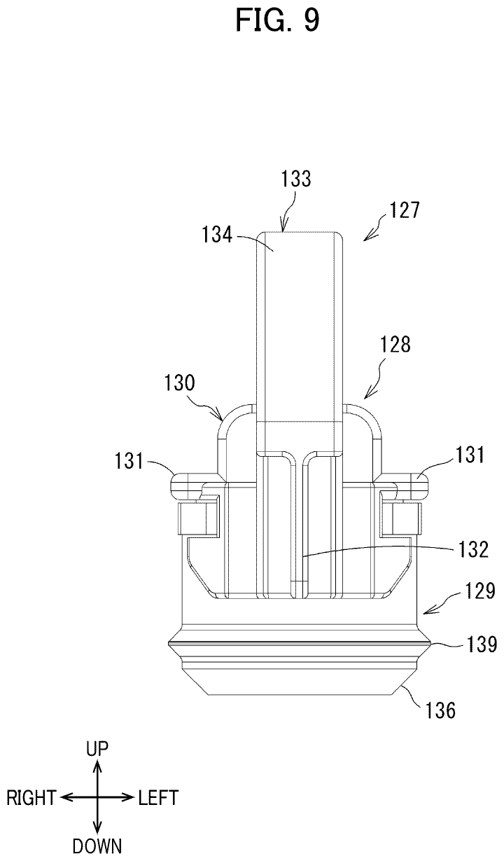

As shown in FIGS. 6 through 12, each tank cap 127 is a cylindrical member having one end closed. Each tank cap 127 is mountable on and detachable from one of the annular walls 122A, 122B, 122C, and 122D. When mounted on the annular walls 122A, 122B, 122C, and 122D, the tank caps 127 closes the openings of the corresponding annular walls 122A, 122B, 122C, and 122D. When detached from the corresponding annular walls 122A, 122B, 122C, and 122D, the tank caps 127 are no longer connected to the ink tank 100 and tank cover 110 but are completely separated therefrom. In other words, the ink tank set 51 does not possess a retaining member configured of an arm or the like for holding the tank caps 127 that have been detached from the annular walls 122A, 122B, 122C, and 122D so as to keep the tank caps 127 connected to the ink tank 100 or tank cover 110.

Each tank cap 127 has a body 128, a rubber portion 129, and a knob portion 133. The body 128 and knob portion 133 are integrally molded of synthetic resin as a single member. The rubber portion 129 is made of rubber. The body 128 has a tubular portion 130, two protruding pieces 131, and a flat plate portion 132.

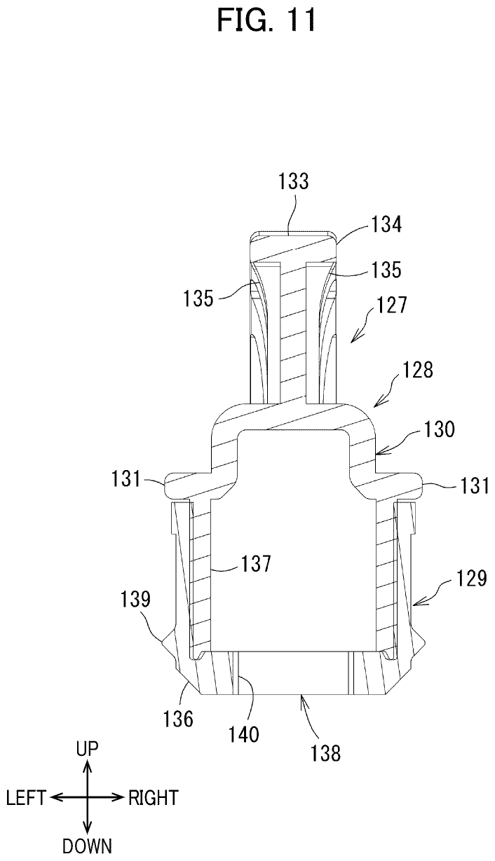

As shown in FIG. 11, the tubular portion 130 has a tubular shape with an open bottom while the tank cap 127 is in a mounted orientation in which the tank cap 127 is mounted on one of the four annular walls 122A, 122B, 122C, and 122D. The lower portion of the tubular portion 130 has a cylindrical shape. The interior space of the tubular portion 130 has an inner diameter greater than the outer diameter of the tank tubes 115A, 115B, 115C, and 115D.

While the tank cap 127 is in the mounted orientation, one protruding piece 131 protrudes leftward from the left portion of the outer peripheral surface of the tubular portion 130 and the other protruding piece 131 protrudes rightward from the right portion of the outer peripheral surface of the tubular portion 130. That is, a pair of protruding pieces 131 protrude in opposite directions from the outer peripheral surface of the tubular portion 130. The protruding pieces 131 have flat plate shapes. The protruding edges of the protruding pieces 131 are linearly shaped in the front-rear direction when the tank cap 127 is in the mounted orientation.

The flat plate portion 132 protrudes rearward from the rear portion of the outer peripheral surface of the tubular portion 130 while the tank cap 127 is in the mounted orientation. The flat plate portion 132 extends in the up-down direction. The external shape of the tank cap 127 establishes the mounted orientation of the tank cap 127 by the flat plate portion 132 being fitted into the slit 73 of the tank cover 110.

The rubber portion 129 is positioned on the outer peripheral surface of the tubular portion 130 below the protruding pieces 131. The rubber portion 129 has a cylindrical shape. The rubber portion 129 covers the portion of the peripheral surface of the tubular portion 130 that is below the protruding pieces 131. The top edge of the rubber portion 129 is in contact with the protruding pieces 131.

The rubber portion 129 has a contact part 136. The contact part 136 extends inward so as to cover the outer peripheral portion of the opening of the tubular portion 130. The contact part 136 is in contact with the end face of the tubular portion that defines the opening of the tubular portion 130. The contact part 136 is in contact with an inner peripheral surface 137 of the tubular portion 130 inside the opening in the tubular portion 130.

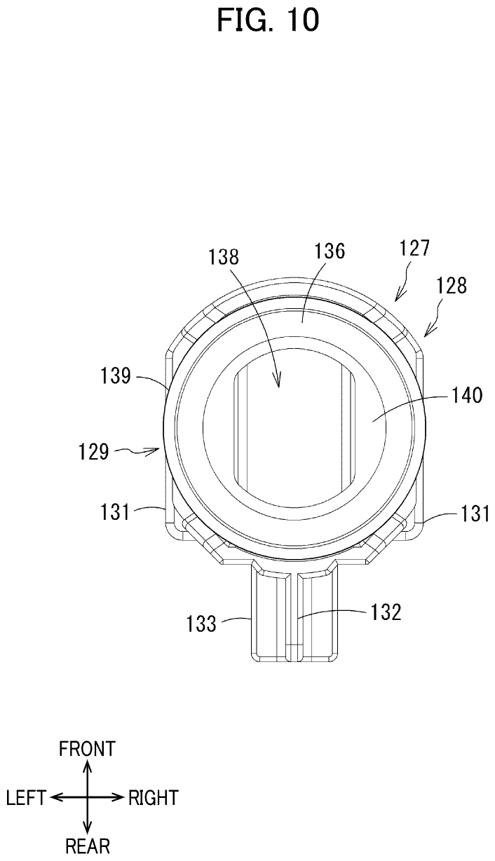

As shown in FIG. 10, two flanges 140 extend from the contact part 136 in the inward direction of the tubular portion 130. The contact part 136 and flanges 140 define an opening 138 of the rubber portion 129. The opening 138 faces downward. One of the two flanges 140 extends rightward from the right edge of the left portion of the contact part 136 and the other of the two flanges 140 extends leftward from the left edge of the right portion of the contact part 136. No flanges 140 are present on the front and rear edges of the contact part 136. The opening 138 is longer in the front-rear direction than in the left-right direction. In other words, the opening 138 has an oblong shape formed by straightening portions on the left and right sides of a circle. The left-right dimension of the opening 138 is greater than the outer diameter of each of the tank tubes 115A, 115B, 115C, and 115D in the ink tank 100.

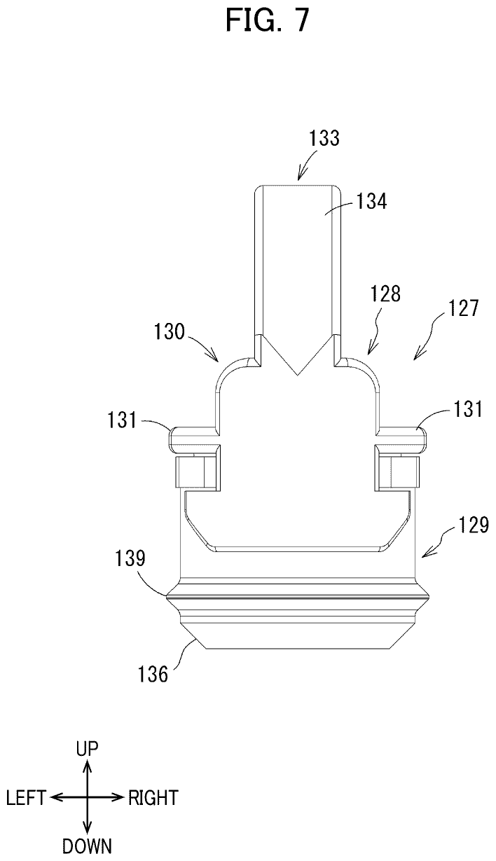

As shown in FIG. 7, the rubber portion 129 has a protruding portion 139 that protrudes annularly from the outer circumferential surface of the rubber portion 129. The outer diameter of the protruding portion 139 is greater than the inner diameters of the annular walls 122A, 122B, 122C, and 122D in the ink tank 100. The rubber portion 129 mounted on the tubular portion 130 can be inserted through press-fitting into the interior space of each of the annular walls 122A, 122B, 122C, and 122D. While the tubular portion 130 is inserted in the interior space of one of the annular walls 122A, 122B, 122C, and 122D, the tubular portion 130 and the rubber portion 129 cover the corresponding communication opening 119A, 119B, 119C, or 119D and corresponding tank tube 115A, 115B, 115C, or 115D from above. The protruding portion 139 makes fluid-tight contact with the inner circumferential surface of the corresponding annular wall 122A, 122B, 122C, or 122D.

The knob portion 133 is positioned above the tubular portion 130 and flat plate portion 132 when the tank cap 127 is in the mounted orientation. The knob portion 133 has a semicircular plate shape that protrudes upward from the outer surfaces of the tubular portion 130 and flat plate portion 132 while the tank cap 127 is in the mounted orientation. The diameter of the semicircular plate shape is approximately the same as the total length of the tubular portion 130 and flat plate portion 132 in the front-rear direction. Therefore, the knob portion 133 is slender in the left-right direction and extends to span between the tubular portion 130 and flat plate portion 132.

The edge of the knob portion 133 that constitutes the circumference of the semicircular plate shape is a thick-walled portion 134 with a thickness dimension oriented in the left-right direction. The knob portion 133 includes a plurality of ridges 135. Each ridge 135 extends along the up-down direction from the bottom edge of the knob portion 133 toward the thick-walled portion 134. The ridges 135 are spaced at intervals in the front-rear direction. The left-right dimension of each ridge 135 gradually increases from the bottom edge of the knob portion 133 toward the thick-walled portion 134. The left-right dimension of the portion of each ridge 135 that is near the thick-walled portion 134 is the same as the left-right dimension of the thick-walled portion 134. The left-right dimension of the portion of the knob portion 133 other than the thick-walled portion 134 and the ridges 135 is smaller than the left-right dimension of the thick-walled portion 134.

The weight of the knob portion 133 is heavier than the combined weight of the body 128 and rubber portion 129. Consequently, when one of the protruding pieces 131 contacts the surface of a floor, the knob portion 133 contacts the floor surface, so that the side of the tank cap 127 on which the rubber portion 129 is provided is lifted further from the surface than the protruding pieces 131.

### <Liquid Bottle 80>

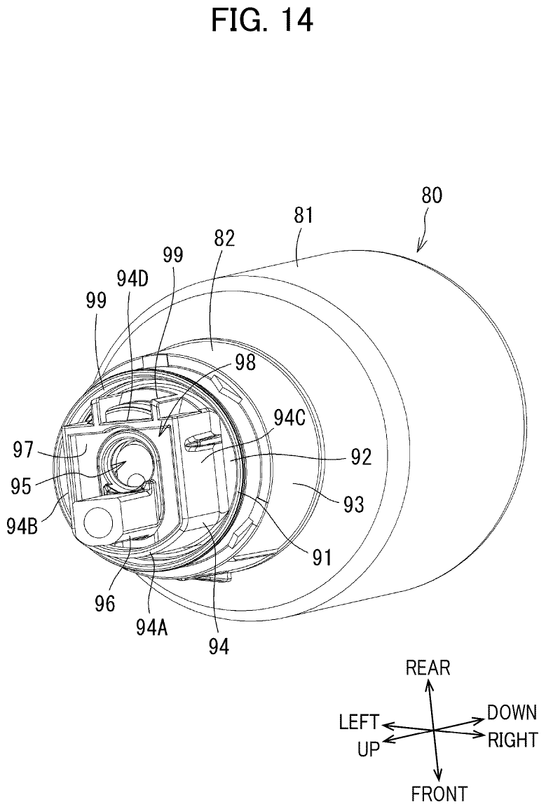

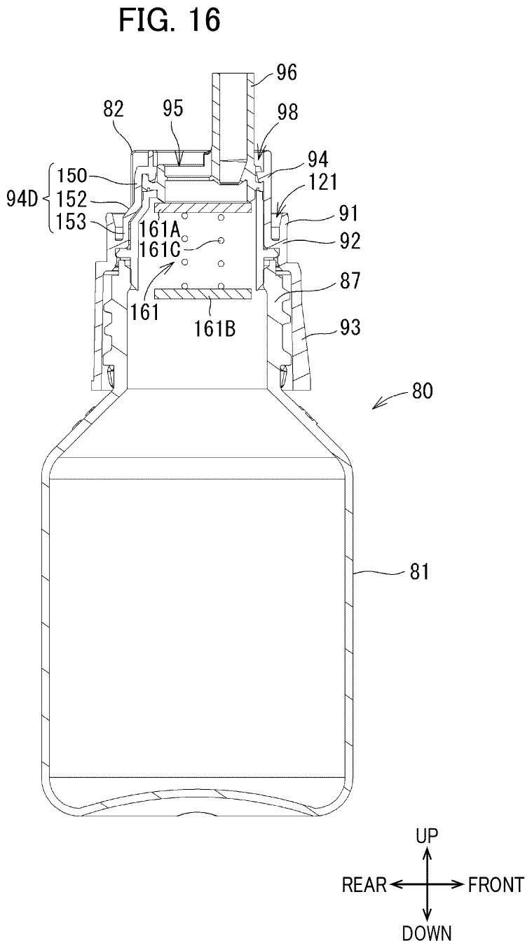

FIG. 14 shows a liquid bottle 80 configured to be connected to the ink tank set 51. As shown in FIGS. 14 and 16, the liquid bottle 80 includes a bottle body 81, a bottle cap 82, and a valve 161. The bottle body 81 has a cylindrical shape. The bottle body 81 includes a mouth portion 87 at the upper portion of the bottle body 81. The mouth portion 87 is smaller in diameter than the lower portion of the bottle body 81. The bottle cap 82 is mounted on the mouth portion 87 to configure a container with interior space for storing ink.

The bottle cap 82 has a circumferential wall 93, a bottom wall 92, a protrusion 94, an opening 95, a bottle tube 96, key members 99, and an annular rib 91. The circumferential wall 93 has a cylindrical shape that extends in the up-down direction. The circumferential wall 93 is screwed onto the mouth portion 87. The bottom wall 92 is an annular wall extending radially inward from the upper portion of the circumferential wall 93.

The protrusion 94 is a tubular wall extending upward from the bottom wall 92. The protrusion 94 can be inserted into the through-hole 72 in the tank cover 110. The outer peripheral surface of the protrusion 94 has a shape conforming to the inner peripheral surface of the through-hole 72. In other words, the shape and size of the outer peripheral surface of the protrusion 94 are approximately the same as the shape and size of the inner peripheral surface of the through-hole 72. The outer peripheral surface of the protrusion 94 is circular on the front side and rectangular on the rear side. In other words, the outer peripheral surface of the protrusion 94 is a quadrilateral whose front side expands forward in an arc shape.

Specifically, the outer peripheral surface of the protrusion 94 has an outer curved surface 94A that expands forward, an outer left flat surface 94B that connects to the left edge of the outer curved surface 94A, an outer right flat surface 94C that connects to the right edge of the outer curved surface 94A, and an outer rear flat surface 94D that connects to the rear edges of the outer left flat surface 94B and outer right flat surface 94C. The outer curved surface 94A conforms to the inner curved surface 72A of the inner peripheral surface of the through-hole 72 when the protrusion 94 is inserted in the through-hole 72. The outer left flat surface 94B conforms to the inner right flat surface 72C of the inner peripheral surface of the through-hole 72 when the protrusion 94 is inserted in the through-hole 72. The outer right flat surface 94C conforms to the inner left flat surface 72B of the inner peripheral surface of the through-hole 72 when the protrusion 94 is inserted in the through-hole 72. The outer rear flat surface 94D is positioned on the opposite side of the opening 95 and bottle tube 96 from the outer curved surface 94A so as to sandwich the opening 95 and bottle tube 96 in the front-rear direction.

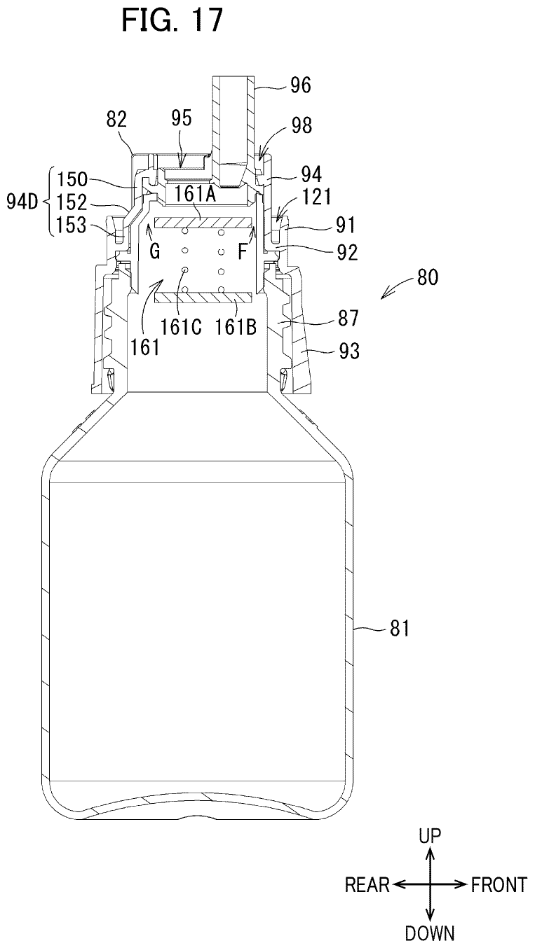

As shown in FIGS. 16 and 17, the outer rear flat surface 94D has an upper flat surface 150, a middle sloped surface 152, and a lower arcuate surface 153. The upper flat surface 150 spans from the top edge of the protrusion 94 to the approximate up-down center portion of the protrusion 94. The middle sloped surface 152 is connected to the bottom edge of the upper flat surface 150. The middle sloped surface 152 slopes relative to the up-down direction so as to extend rearward toward the bottom. The lower arcuate surface 153 spans from the bottom edge of the middle sloped surface 152 to the top surface of the bottom wall 92. The lower arcuate surface 153 is an arcuate surface expanding rearwardly when viewed from above. The outer rear flat surface 94D conforms to the inner rear flat surface 72D of the inner peripheral surface of the through-hole 72 when the protrusion 94 is inserted in the through-hole 72.

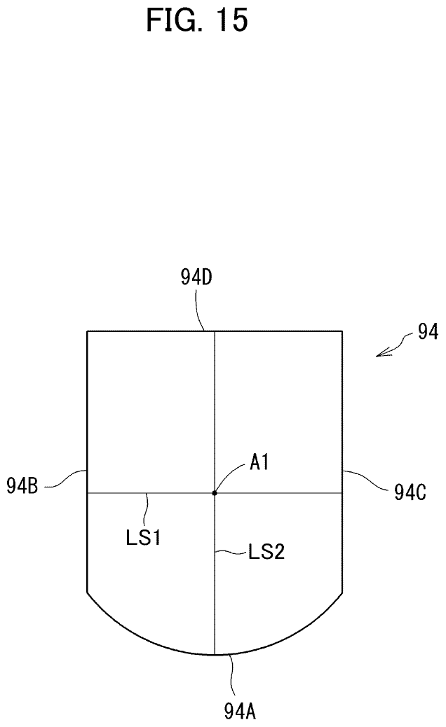

As shown in FIG. 15, the outer peripheral surface of the protrusion 94 is not rotationally symmetric about the center A1 of the protrusion 94. Rotational symmetry means that during a process of rotating an object 360 degrees about its center, the object perfectly overlaps its original shape two or more times. For example, if the outer peripheral surface of the protrusion 94 were an equilateral triangle, the protrusion 94 would overlap itself three times during a process of being rotated 360 degrees about the center A1. Therefore, the outer peripheral surface of the protrusion 94 would have rotational symmetry with respect to the center A1 of the protrusion 94. However, since the protrusion 94 in the present embodiment overlaps itself exactly once during a process of being rotated 360 degrees about the center A1, the outer peripheral surface of the protrusion 94 is not rotationally symmetric about the center A1. Thus, the shape of the protrusion 94 determines one orientation in which the protrusion 94 can be inserted into the through-hole 72.

The center A1 is the point where the midpoint of a line segment defining the left-right dimension of the protrusion 94 coincides with the midpoint of a line segment defining the front-rear dimension of the protrusion 94 when viewing the protrusion 94 from above. In other words, the center A1 is the center of the protrusion 94 both in the front-rear direction and in the left-right direction. That is, the center A1 is the front-rear center of the protrusion 94 and is also the left-right center of the protrusion 94. In the present embodiment, the center A1 is the point at which the midpoint of a line segment LS1 connecting the outer left flat surface 94B and the outer right flat surface 94C coincides with the midpoint of a line segment LS2 connecting the outer curved surface 94A and the outer rear flat surface 94D.

The protrusion 94 has a top wall 97 positioned in the upper edge portion of the protrusion 94. The top wall 97 is slightly lower than the top edge of the protrusion 94. The top wall 97 has a top surface orthogonal to the up-down direction. The top wall 97 is a flat plate that extends in the front-rear and left-right directions. A recess 98 is defined by the top surface of the top wall 97 and the inner peripheral surface of the protrusion 94. The inner peripheral surface of the recess 98 are parallel to the outer peripheral surface of the protrusion 94.

The key members 99 extend rearward from the outer rear flat surface 94D on the outer peripheral surface of the protrusion 94. The positions and shapes of the key members 99 conform to the positions and shapes of the keyways 74 of the through-hole 72 to which the liquid bottle 80 is to be connected. In other words, the shapes of the key members 99 and the positions of the key members 99 relative to the outer rear flat surface 94D differ among the four liquid bottles 80 that store ink in the colors black, yellow, cyan, and magenta. The key members 99 of the liquid bottle 80 shown in FIG. 14 conform to the leftmost through-hole 72 in the tank cover 110. The liquid bottle 80 whose key members conform to the through-hole 72 positioned second from the right is an example of the first liquid bottle. The liquid bottle 80 whose key members conform to the rightmost through-hole 72 is an example of the second liquid bottle.

The opening 95 and bottle tube 96 are positioned on the top surface of the top wall 97 in the protrusion 94. The opening 95 is positioned farther rearward than the center A1 of the protrusion 94. The opening 95 has a circular shape. The opening 95 provides communication between the inner space of the liquid bottle 80 and the exterior of the liquid bottle 80. The bottle tube 96 is positioned farther forward than the center A1 of the protrusion 94. The bottle tube 96 is a tubular body whose inner space provides communication between the inner space of the liquid bottle 80 and the exterior of the liquid bottle 80. The bottle tube 96 has a polygonal external shape that conforms to the shape of the communication openings 119A, 119B, 119C, and 119D in the ink tank 100. That is, the external shape of the bottle tube 96 is circular on the front side and rectangular on the rear side. In other words, the bottle tube 96 has a quadrilateral shape with the front side expanding forward in an arc shape.

The annular rib 91 is provided on the outer peripheral portion of the top surface of the bottom wall 92. The annular rib 91 is located outward of and apart from the protrusion 94. The annular rib 91 protrudes upward from the top surface of the bottom wall 92. The annular rib 91 extends in an annular shape along the outer periphery of the top surface of the bottom wall 92. The annular rib 91 surrounds the outer peripheral surface of the protrusion 94. This configuration forms an annular ink holding space 121, which is defined by the inner circumferential surface of the annular rib 91, the outer peripheral surface of the protrusion 94, and the top surface of the bottom wall 92.

As shown in FIG. 16, the valve 161 is positioned in the interior space of the protrusion 94. The valve 161 has a valve body 161A, a valve seat 161B, and a coil spring 161C. The valve body 161A has a flat plate shape that expands in the front-rear and left-right directions. The valve body 161A has an oblong shape conforming to the inner surface of the protrusion 94 when viewed in the up-down direction. The bottle tube 96 has a top opening and a bottom opening. The top opening opens to the exterior of the liquid bottle 80. The bottom opening opens inside the liquid bottle 80. The top surface of the valve body 161A closes the opening 95 and the bottom opening of the bottle tube 96.

The valve seat 161B is positioned below the valve body 161A. The valve seat 161B has a flat plate shape that expands in the front-rear and left-right directions. The valve seat 161B is fixed to the inner surface of the protrusion 94. The coil spring 161C is positioned between the valve body 161A and valve seat 161B. The coil spring 161C is compressible in the up-down direction. The bottom end of the coil spring 161C is supported by the top surface of the valve seat 161B. The top end of the coil spring 161C urges the valve body 161A upward. Thus, the coil spring 161C urges the valve body 161A so that the top surface of the valve body 161A keeps the opening 95 and the bottom opening of the bottle tube 96 closed.

The valve 161 is movable in the up-down direction between a closed position and an open position. In the closed position shown in FIG. 16, the top surface of the valve body 161A closes the opening 95 and the bottom opening of the bottle tube 96. In the open position shown in FIG. 17, the valve 161 has been moved downward from the open position against the urging force of the coil spring 161C.

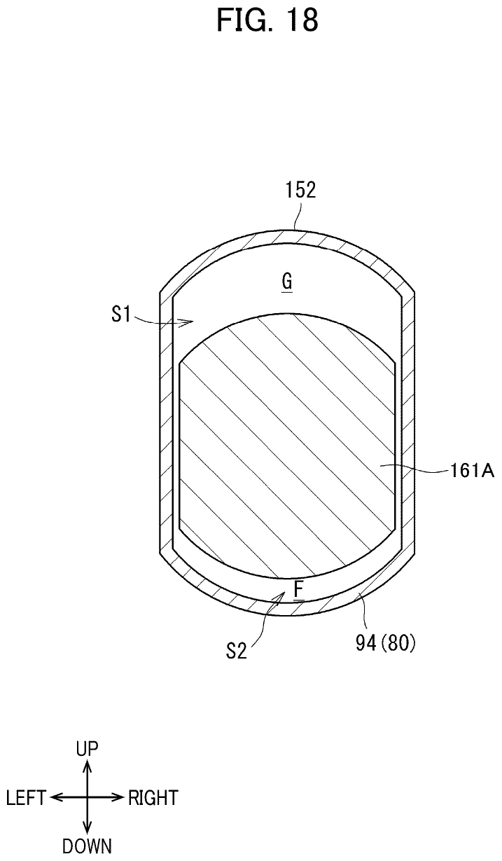

In the open position, the valve 161 defines an air channel G and an ink channel F between the valve 161 and the inner surface of the liquid bottle 80. The ink channel F is a channel through which ink flows. The ink channel F is defined by the inner surface of the liquid bottle 80 and the front end face of the valve 161 in the open position. The air channel G is a channel through which air flows. The air channel G is defined by the inner surface of the liquid bottle 80 and the rear end face of the valve 161 in the open position. The air channel G has a larger area than the ink channel F. Specifically, in a cross section of the liquid bottle 80 taken along a horizontal plane that includes the valve body 161A of the valve 161 in the open position, the area S1 enclosed by the rear end face of the valve body 161A and the inner surface of the liquid bottle 80 is greater than the area S2 enclosed by the front end face of the valve body 161A and the inner surface of the liquid bottle 80, as illustrated in FIG. 18.

<Connection between Liquid Bottle 80 and Ink Tank 100>

First, the user grasps the orientation of the liquid bottle 80 at which the protrusion 94 can be inserted into the leftmost through-hole 72 in the tank cover 110. Since the outer curved surface 94A and outer rear flat surface 94D of the protrusion 94 are positioned on opposite sides of the opening 95 and bottle tube 96 in the front-rear direction, the user can easily identify the orientation at which the protrusion 94 is insertable into the through-hole 72.

Next, the user inserts the protrusion 94 into the leftmost through-hole 72. At this time, the key members 99 on the bottle cap 82 are inserted into the keyways 74 of the through-hole 72. If the user were to attempt to insert the protrusion 94 into an incorrect through-hole 72 at this time, such as the through-hole 72 positioned second from the left, the key members 99 would not enter the keyways 74, suppressing the liquid bottle 80 from being mounted in the incorrect position. At the same time the key members 99 are inserted into the keyways 74, the bottle tube 96 is inserted into the communication opening 119A of the ink tank 100 and the tank tube 115A is inserted into the opening 95 of the liquid bottle 80. At this time, the tank tube 115A presses the valve body 161A diagonally upward and forward so that the valve body 161A moves from the closed position to the open position against the urging force of the coil spring 161C. Through this operation, the liquid bottle 80 becomes connected to the ink tank 100. In this state, the bottle tube 96 is positioned below the tank tube 115A. The air channel G is positioned above the ink channel F and the distal end of the tank tube 115A. The outer curved surface 94A on the outer peripheral surface of the protrusion 94 is supported on the inner curved surface 72A on the inner peripheral surface of the through-hole 72.

When the liquid bottle 80 is connected to the ink tank 100, ink stored in the liquid bottle 80 flows into the ink chamber 111A through the ink channel F and the interior space in the bottle tube 96. As ink flows into the ink chamber 111A, air enters the ink chamber 111A through the atmospheric communication port 112A and flows into the liquid bottle 80 through the tank tube 115A. Air flowing into the liquid bottle 80 moves upward in the liquid bottle 80 through the air channel G positioned above the distal end of the tank tube 115A. As a result, ink in the liquid bottle 80 is supplied into the ink chamber 111A through the occurrence of gas-liquid replacement.

### <Mounting Tank Cap 127 on Ink Tank Set 51>

When the liquid bottle 80 is not connected to the ink tank set 51, the tank caps 127 are mounted on the ink tank set 51. To mount the tank cap 127 on the ink tank set 51, the user grips the knob portion 133 of the tank cap 127 and holds the tank cap 127 in an orientation that allows the flat plate portion 132 to be inserted into the slit 73 in the tank cover 110.

As the flat plate portion 132 is inserted into the slit 73 of the tank cover 110, the rubber portion 129 of the tank cap 127 is inserted through the through-hole 72 of the tank cover 110 into the annular wall 122A of the ink tank 100.

As shown in FIG. 12, when the flat plate portion 132 of the tank cap 127 is inserted into the slit 73 of the tank cover 110, the tank cap 127 is in the mounted orientation in which the longitudinal direction of the opening 138 of the rubber portion 129 crosses the horizontal direction. Specifically, in the mounted orientation, the longitudinal direction of the opening 138 is orthogonal to the left-right direction and is sloped relative to the front-rear direction (more specifically, sloped upward to the rear). In the mounted orientation, the flanges 140 are positioned to the left and right of the opening 138 and not above and below the opening 138.

When the tank cap 127 is in the mounting orientation, the tank tube 115A is inserted in the tubular portion 130 of the tank cap 127 through the opening 138 in the rubber portion 129, as illustrated in FIG. 13. In this state, a gap is formed between the tank tube 115A and the inner peripheral surface 137 of the tubular portion 130 of the tank cap 127. With this configuration, ink deposited on the tank tube 115A due to connection of the liquid bottle 80 to the ink tank 100 is not likely to move onto the inner peripheral surface 137 of the tubular portion 130.

However, large ink droplets deposited on the outer surface of the tank tube 115A may drop off the tank tube 115A and become deposited on the inner peripheral surface 137 of the tubular portion 130. Ink droplets deposited on the inner peripheral surface 137 of the tubular portion 130 move downward along the inner peripheral surface 137 due to gravity. Since the flanges 140 are not located below the opening 138, ink droplets deposited on the inner peripheral surface 137 can easily move to the inside of the annular wall 122A through the opening 138. Ink droplets that have moved inside the annular wall 122A flow into the ink chamber 111A through the communication opening 119A. If the flange 140 were to be located below the opening 138, ink droplets would become dammed by the flange 140 and would be unlikely to move to the inside of the annular wall 122A through the opening 138.

In a process of the tank cap 127 reaching the mounted orientation, the protruding portion 139 of the rubber portion 129 slides against an inner circumferential surface 123 of the annular wall 122A. Since the contact part 136 is in contact with the end face defining the opening of the tubular portion 130, the rubber portion 129 does not shift in position relative to the tubular portion 130. Since the protruding portion 139 of the rubber portion 129 makes fluid-tight contact with the inner circumferential surface 123 of the annular wall 122A, ink stored in the ink chamber 111A is suppressed from flowing out of the ink tank 100 through the tank tube 115A and the communication opening 119A.

### Effects of the Embodiment

In the multifunction peripheral 10, the left-right center C1 of the annular wall 122A, the left-right center C2 of the annular wall 122B, the left-right center C3 of the annular wall 122C, and the left-right center C4 of the annular wall 122D are offset rightward from the left-right center D1 of the ink chamber 111A, the left-right center D2 of the ink chamber 111B, the left-right center D3 of the ink chamber 111C, and the left-right center D4 of the ink chamber 111D, respectively. Therefore, the four annular walls 122A, 122B, 122C, and 122D can be arranged in the top wall 104, even though the outer diameter L3 of each of the annular walls 122A, 122B, 122C, and 122D is greater than the left-right length L2 of each of the ink chambers 111A, 111B, and 111C. If the left-right centers C1, C2, C3, and C4 of the respective annular walls 122A, 122B, 122C, and 122D were aligned with the left-right centers D1, D2, D3, and D4 of the respective ink chambers 111A, 111B, 111C, and 111D, the annular walls 122A, 122B, 122C, and 122D adjacent in the left-right direction would contact each other, necessitating that the left-right length L2 of each of the ink chambers 111A, 111B, and 111C be greater than the outer diameter L3. Consequently, the left-right dimension of the ink tank 100 would increase.

However, in the multifunction peripheral 10, the left-right center C1 of the annular wall 122A, the left-right center C2 of the annular wall 122B, the left-right center C3 of the annular wall 122C, and the left-right center C4 of the annular wall 122D are offset rightward from the left-right center D1 of the ink chamber 111A, the left-right center D2 of the ink chamber 111B, the left-right center D3 of the ink chamber 111C, and the left-right center D4 of the ink chamber 111D, respectively. The offset amount B1 by which the left-right center C1 of the annular wall 122A is offset from the left-right center D1 of the ink chamber 111A, the offset amount B2 by which the left-right center C2 of the annular wall 122B is offset from the left-right center D2 of the ink chamber 111B, the offset amount B3 by which the left-right center C3 of the annular wall 122C is offset from the left-right center D3 of the ink chamber 111C, and the offset amount B4 by which the left-right center C4 of the annular wall 122D is offset from the left-right center D4 of the ink chamber 111D are different from each other. Therefore, the four annular walls 122A, 122B, 122C, and 122D can be arranged at equal intervals in the top wall 104, even though the outer diameter L3 of each of the annular walls 122A, 122B, 122C, and 122D is greater than the left-right length L2 of each of the ink chambers 111A, 111B, and 111C. Further, the distance in the left-right direction between the left-right center C2 of the annular wall 122B and the left-right center C3 of the annular wall 122C is shorter than if the left-right center C2 of the annular wall 122B were offset leftward from the left-right center D2 of the ink chamber 111B and the left-right center C3 of the annular wall 122C were offset rightward from the left-right center D3 of the ink chamber 111C, for example.

In the multifunction peripheral 10, the left-right length L1 of the ink chamber 111D is greater than the left-right length L2 of the ink chamber 111C. Accordingly, the annular wall 122D can be arranged such that the right end of the annular wall 122D does not protrude rightward from the right wall 102, even though the right end of the annular wall 122C is positioned further rightward than the partition wall 107C.

Since the ink chamber 111D having a large capacity stores black ink, which is consumed in higher quantities, the multifunction peripheral 10 in the above embodiment can reduce the frequency at which the tank needs to be refilled with ink.

Since the annular wall 122C surrounds the tank tube 115C and communication opening 119C in the multifunction peripheral 10, the left-right length (i.e., the outer diameter L3 in the above embodiment) of the annular wall 122C is long. Since the annular wall 122D surrounds the tank tube 115D and communication opening 119D, the left-right length (i.e., the outer diameter L3 in the above embodiment) of the annular wall 122D is long. Since the annular wall 122C is positioned to span between the ink chamber 111C and the ink chamber 111D in the left-right direction, the annular wall 122C can easily be arranged in the top wall 104. Further, the annular wall 122D can be arranged such that the right end of the annular wall 122D does not protrude rightward from the right wall 102, even though the annular wall 122C is arranged to span between the ink chamber 111C and the ink chamber 111D in the left-right direction.

As shown in FIG. 20A, in the multifunction peripheral 10, the center K3 in a circular cross section of the annular wall 122C is offset forward from the center T3 in a circular cross section of the tank tube 115C. Therefore, sufficient space can be allocated on the front side of the tank tube 115C for arranging the communication opening 119C between the outer circumferential surface of the tank tube 115C and the inner circumferential surface of the annular wall 122C, even if the diameter of the annular wall 122C is reduced, compared to an assumed comparative example in which the center K3 of the annular wall 122C is aligned with the center T3 of the tank tube 115C, as illustrated in FIG. 20B. Accordingly, the diameter of the annular wall 122C is smaller than the case shown in FIG. 20B. Similarly, the diameter of the annular wall 122D is smaller.

In the multifunction peripheral 10, the ink chamber 111A and ink chamber 111B are adjacent to each other in the left-right direction with the partition wall 107A interposed therebetween. The ink chamber 111B and ink chamber 111C are adjacent to each other in the left-right direction with the partition wall 107B interposed therebetween. The ink chamber 111C and ink chamber 111D are adjacent to each other in the left-right direction with the partition wall 107C interposed therebetween. Consequently, it can be difficult to check the levels of liquid in the four ink chambers 111A, 111B, 111C, and 111D simultaneously from one side in the left-right direction. However, in the multifunction peripheral 10, the user can check the liquid levels in the ink chambers 111A, 111B, and 111C through the left sloped surfaces 151A of the three recessed surfaces 151 from the right side of the ink tank 100 and can check the liquid levels in the ink chambers 111B, 111C, and 111D through the right sloped surfaces 151C of the three recessed surfaces 151 from the left side of the ink tank 100. Thus, the user can simultaneously check levels of liquid in the four ink chambers 111A, 111B, 111C, and 111D, even from one side of the ink tank 100 in the left-right direction.

In the multifunction peripheral 10, if ink drips from the bottle tube 96 of the liquid bottle 80 when the liquid bottle 80 is extracted from the ink tank set 51, ink flows diagonally downward and forward along the sloped surface 104A and is subsequently stopped by the barrier wall 109. Once stopped by the barrier wall 109, the ink accumulates on the barrier wall 109 while flowing along the barrier wall 109 in the left-right direction. Thus, the multifunction peripheral 10 suppresses ink from soiling the front surface 101A of the front wall 101 of the ink tank 100.

In the ink tank 100, the offset of the left-right center of the communication part 113C relative to the left-right center D3 of the ink chamber 111C and the offset of the left-right center of the communication part 113D relative to the left-right center D4 of the ink chamber 111D are different from each other in a direction from the ink chamber 111C toward the ink chamber 111D along the left-right direction (i.e., in the rightward direction). Accordingly, the distance in the left-right direction between the left-right center of the communication part 113C and the left-right center of the communication part 113D can be made shorter than if the left-right center of the communication part 113C is offset from the left-right center D3 of the ink chamber 111C in a direction from the ink chamber 111D toward the ink chamber 111C and the left-right center of the communication part 113D is offset from the left-right center D4 of the ink chamber 111D in a direction from the ink chamber 111C toward the ink chamber 111D.

In the ink tank 100, the left-right length L1 of the ink chamber 111D is greater than the left-right length L2 of the ink chamber 111C. Accordingly, the communication part 113D can be easily contained within the width (the left-right dimension) of the ink chamber 111D, even though the communication part 113C spans between the ink chamber 111C and the ink chamber 111D.

In the ink tank 100, the communication part 113C includes the annular wall 122C on which the tank cap 127 is mountable, the annular wall 122C surrounds the communication opening 119C, and the opening of the annular wall 122C is closed by the tank cap 127 when the tank cap 127 is mounted on the annular wall 122C. The communication part 113D includes the annular wall 122D on which the tank cap 127 is mountable, the annular wall 122D surrounds the communication opening 119D, and the opening of the annular wall 122D is closed by the tank cap 127 when the tank cap 127 is mounted on the annular wall 122D. The distance L6 in the left-right direction between the right surface 107BR and the left-right center C3 of the annular wall 122C and the distance L7 in the left-right direction between the right surface 107CR and the left-right center C4 of the annular wall 122D are different from each other. In addition, a portion of the annular wall 122C and a portion of the ink chamber 111D are at the same position in the left-right direction.

In the above configuration, since the annular wall 122C surrounds the communication opening 119C, the left-right length (the width) of the communication part 113C tends to be longer. Since the annular wall 122D surrounds the communication opening 119D, the left-right length (the width) of the communication part 113D also tends to be longer. With the above configuration, a portion of the annular wall 122C and a portion of the ink chamber 111D are at the same position in the left-right direction, so that the annular wall 122C spans between the ink chamber 111C and the ink chamber 111D. This configuration can facilitate the layout of the communication part 113C, even when the communication part 113C has a large left-right dimension. Further, the communication part 113D can easily be contained within the width (the left-right dimension) of the ink chamber 111D, even when the communication part 113D has a large left-right dimension.

In the ink tank 100, the communication part 113C includes the tank tube 115C that provides communication between the interior and exterior of the ink chamber 111C, and the communication part 113D includes the tank tube 115D that provides communication between the interior and exterior of the ink chamber 111D. In addition, the annular wall 122C surrounds the tank tube 115C and the communication opening 119C, and the annular wall 122D surrounds the tank tube 115D and the communication opening 119D.

In the above configuration, since the annular wall 122C surrounds the tank tube 115C and the communication opening 119C, the left-right length (the width) of the communication part 113C tends to be longer. Since the annular wall 122D surrounds the tank tube 115D and the communication opening 119D, the left-right length (the width) of the communication part 113D also tends to be longer. The above configuration can facilitate the layout of the communication part 113C, even when the communication part 113C has a large left-right dimension. Further, the communication part 113D can easily be contained within the width (the left-right dimension) of the ink chamber 111D, even when the communication part 113D has a large left-right dimension.

While the invention has been described in conjunction with the example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

### Variations of the Embodiment

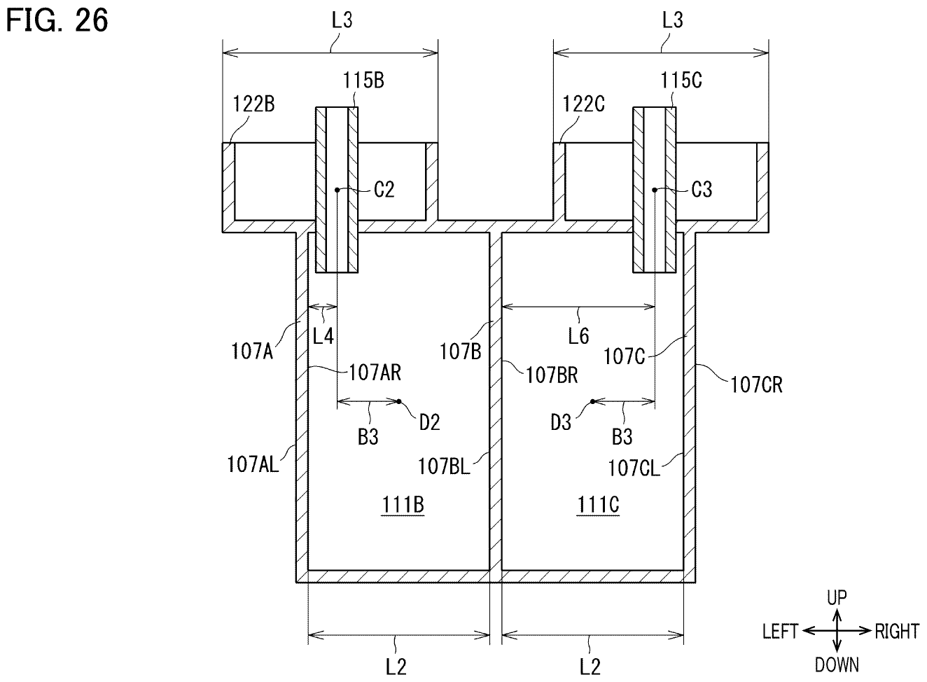

In the embodiment described above, the left-right centers C1, C2, C3, and C4 of the respective annular walls 122A, 122B, 122C, and 122D are offset rightward from the left-right centers D1, D2, D3, and D4 of the respective ink chambers 111A, 111B, 111C, and 111D. However, the left-right center C2 of the annular wall 122B may be offset leftward from the left-right center D2 of the ink chamber 111B while the left-right center C3 of the annular wall 122C may be offset rightward from the left-right center D3 of the ink chamber 111C, as illustrated in FIG. 26. The offset amount by which the left-right center C2 of the annular wall 122B is offset from the left-right center D2 of the ink chamber 111B is equivalent to the offset amount B3 by which the left-right center C3 of the annular wall 122C is offset from the left-right center D3 of the ink chamber 111C. Further, since the left-right center C2 of the annular wall 122B is offset leftward from the left-right center D2 of the ink chamber 111B and the left-right center C3 of the annular wall 122C is offset rightward from the left-right center D3 of the ink chamber 111C, the offset of the left-right center C2 of the annular wall 122B relative to the left-right center D2 of the ink chamber 111B and the offset of the left-right center C3 of the annular wall 122C relative to the left-right center D3 of the ink chamber 111C are different from each other in the direction from the ink chamber 111B toward the ink chamber 111C along the left-right direction (i.e., in the rightward direction). In the variation shown in FIG. 26, the annular walls 122B and 122C can be arranged in the top wall 104, even though the outer diameter L3 of each of the annular walls 122B and 122C is greater than the left-right length L2 of each of the ink chambers 111B and 111C. In other words, the annular walls 122B and 122C can be arranged in the top wall 104, without increasing the left-right length L2 of the ink chambers 111B and 111C.

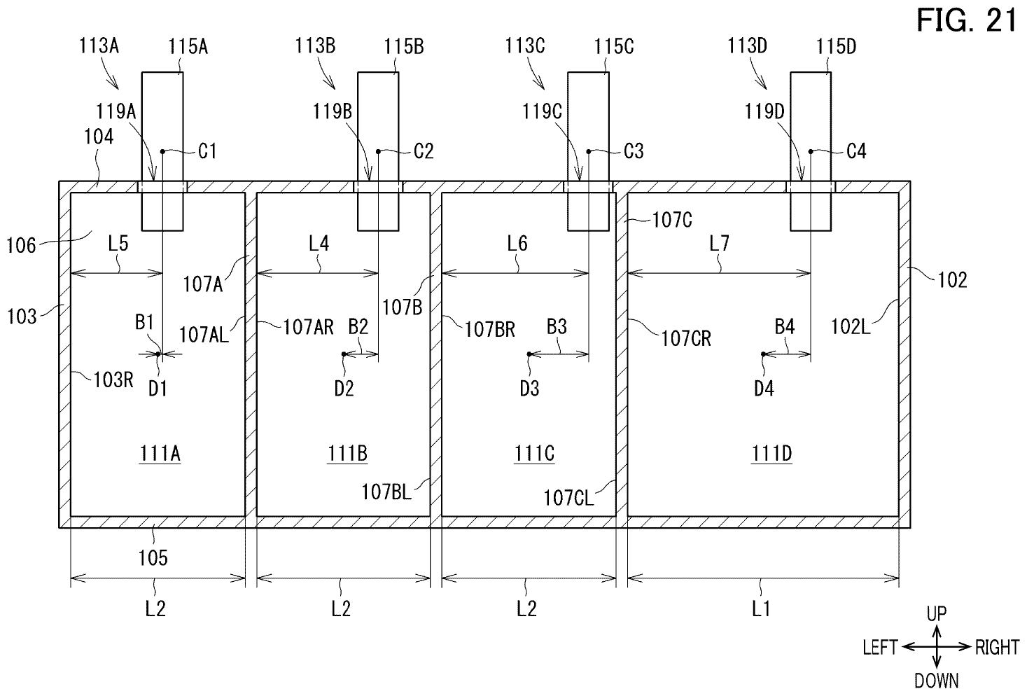

While the ink tank 100 of the embodiment described above includes the four annular walls 122A, 122B, 122C, and 122D, these annular walls 122A, 122B, 122C, and 122D may be omitted, as in the example shown in FIG. 21. Note that the left-right centers C1, C2, C3, and C4 shown in FIG. 21 denote the left-right centers of the tank tubes 115A, 115B, 115C, and 115D of this variation, respectively. In addition, the left-right positions of the left-right centers C1, C2, C3, and C4 in the variation shown in FIG. 21 are the same as the left-right positions of the left-right centers C1, C2, C3, and C4 in the above-described embodiment shown in FIG. 19, respectively. However, the left-right positions of the left-right centers C1, C2, C3, and C4 in the variation shown in FIG. 21 need not necessarily be the same as the left-right positions of the left-right centers C1, C2, C3, and C4 in the above-described embodiment shown in FIG. 19, respectively. In this case, the tank tube 115C and the communication opening 119C are an example of the first communication part, and the tank tube 115D and the communication opening 119D are an example of the second communication part.

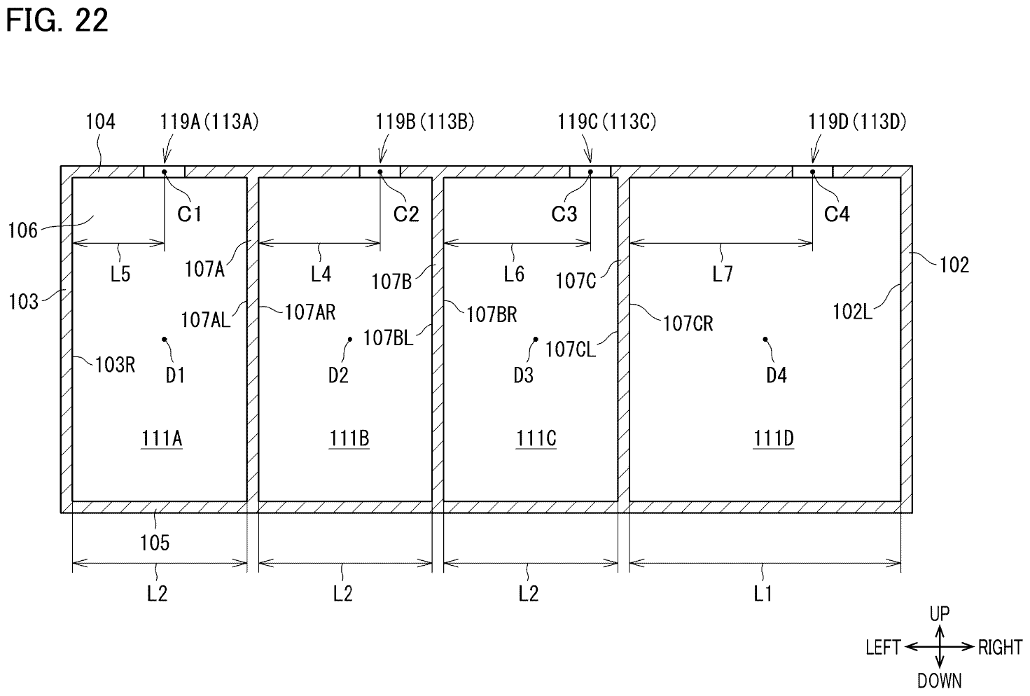

While the ink tank 100 in the embodiment described above includes the four annular walls 122A, 122B, 122C, and 122D and the four tank tubes 115A, 115B, 115C, and 115D, these annular walls 122A, 122B, 122C, and 122D and tank tubes 115A, 115B, 115C, and 115D may be omitted, as in the example of FIG. 22. In this case, the opening 95 and valve 161 of the liquid bottle 80 are also omitted. The bottle tube 96 preferably has two channels including a channel through which ink flows and a channel through which air flows. Note that the left-right centers C1, C2, C3, and C4 shown in FIG. 22 denote the left-right centers of the communication openings 119A, 119B, 119C, and 119D of this variation, respectively. In addition, the left-right positions of the left-right centers C1, C2, C3, and C4 in the variation shown in FIG. 22 are the same as the left-right positions of the left-right centers C1, C2, C3, and C4 in the above-described embodiment shown in FIG. 19, respectively. However, the left-right positions of the left-right centers C1, C2, C3, and C4 in the variation shown in FIG. 22 need not necessarily be the same as the left-right positions of the left-right centers C1, C2, C3, and C4 in the above-described embodiment shown in FIG. 19, respectively. In the variation shown in FIG. 22, the communication opening 119C is an example of the first communication part and the communication opening 119D is an example of the second communication part.

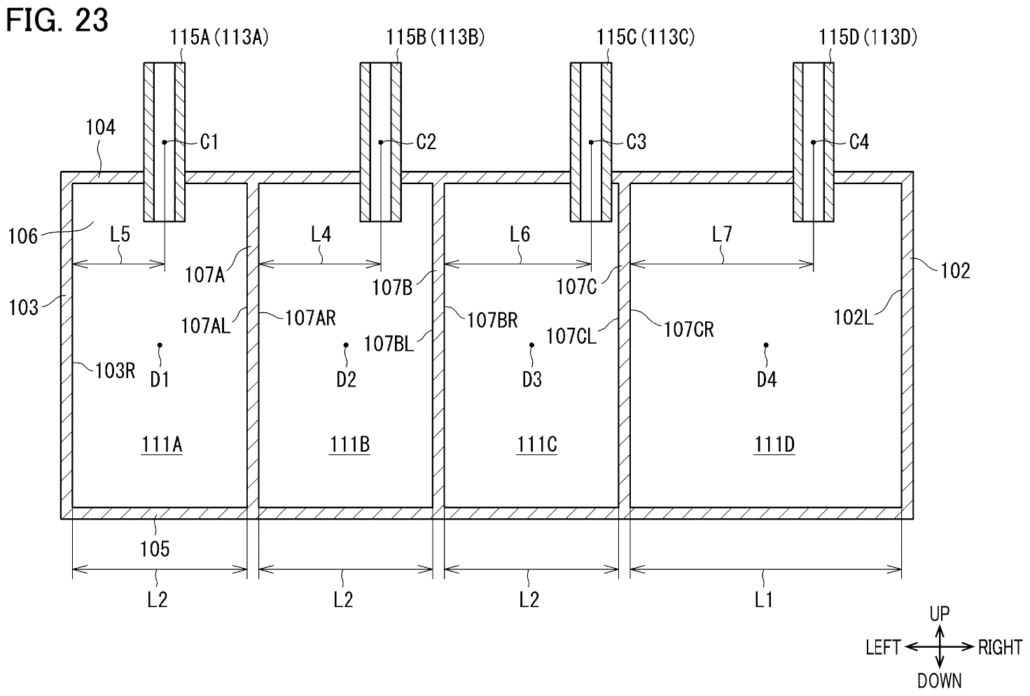

The four communication openings 119A, 119B, 119C, and 119D and the four annular walls 122A, 122B, 122C, and 122D described in the above embodiment may be omitted, as illustrated in the example of FIG. 23. In this case, the bottle tube 96 is omitted from the liquid bottle 80. Each of the tank tubes 115A, 115B, 115C, and 115D preferably possesses two channels including a channel through which ink flows and a channel through which air flows. Note that the left-right centers C1, C2, C3, and C4 shown in FIG. 23 denote the left-right centers of the tank tubes 115A, 115B, 115C, and 115D of this variation, respectively. In addition, the left-right positions of the left-right centers C1, C2, C3, and C4 in the variation shown in FIG. 23 are the same as the left-right positions of the left-right centers C1, C2, C3, and C4 in the above-described embodiment shown in FIG. 19, respectively. However, the left-right positions of the left-right centers C1, C2, C3, and C4 in the variation shown in FIG. 23 need not necessarily be the same as the left-right positions of the left-right centers C1, C2, C3, and C4 in the above-described embodiment shown in FIG. 19, respectively. In the variation shown in FIG. 23, the tank tube 115C is an example of the first communication part and the tank tube 115D is an example of the second communication part. As an alternative, only the communication openings 119A, 119B, 119C, and 119D may be omitted from the ink tank 100.

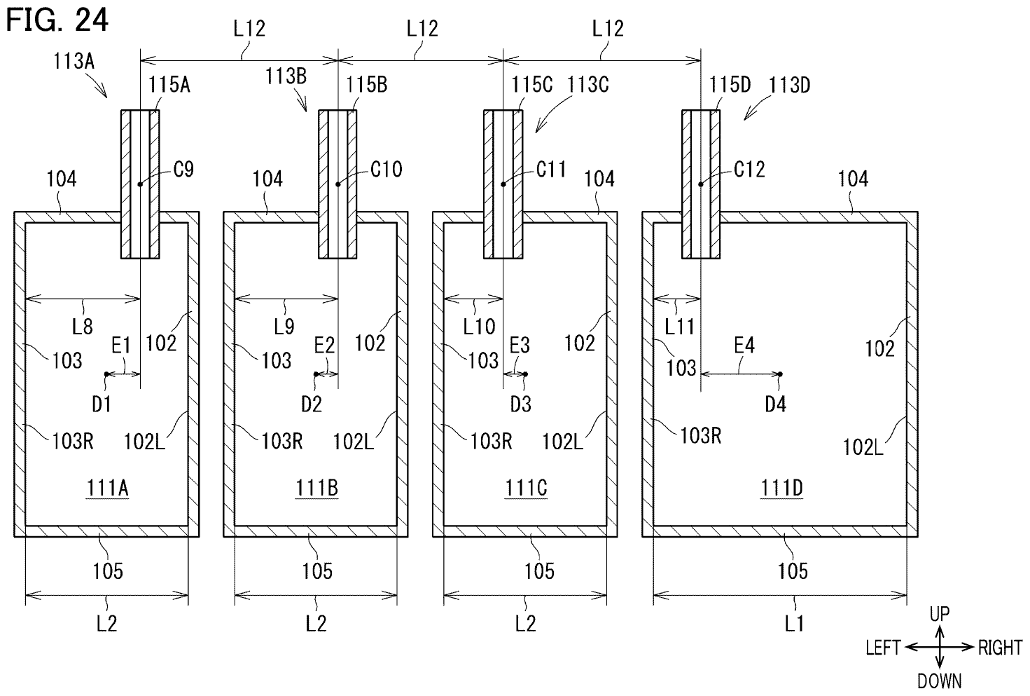

In the above embodiment, the four ink chambers 111A, 111B, 111C, and 111D are adjacent to each other in the left-right direction with the partition walls 107A, 107B, and 107C interposed therebetween. However, the ink chambers 111A, 111B, 111C, and 111D may be spaced apart from each other in the left-right direction, as illustrated in FIG. 24. The left-right center C9 of the tank tube 115A is offset rightward from the left-right center D1 of the ink chamber 111A. The left-right center C10 of the tank tube 115B is offset rightward from the left-right center D2 of the ink chamber 111B. The offset amount E2 by which the left-right center C10 of the tank tube 115B is offset from the left-right center D2 of the ink chamber 111B is smaller than the offset amount E1 by which the left-right center C9 of the tank tube 115A is offset from the left-right center D1 of the ink chamber 111A. The left-right center C11 of the tank tube 115C is offset leftward from the left-right center D3 of the ink chamber 111C. The offset amount E3 by which the left-right center C11 of the tank tube 115C is offset from the left-right center D3 of the ink chamber 111C is the same as the offset amount E2 by which the left-right center C10 of the tank tube 115B is offset from the left-right center D2 of the ink chamber 111B. The left-right center C12 of the tank tube 115D is offset leftward from the left-right center D4 of the ink chamber 111D. The offset amount E4 by which the left-right center C12 of the tank tube 115D is offset from the left-right center D4 of the ink chamber 111D is greater than the offset amount E1 by which the left-right center C9 of the tank tube 115A is offset from the left-right center D1 of the ink chamber 111A. Further, the offset of the left-right center C9 of the tank tube 115A relative to the left-right center D1 of the ink chamber 111A, the offset of the left-right center C10 of the tank tube 115B relative to the left-right center D2 of the ink chamber 111B, the offset of the left-right center C11 of the tank tube 115C relative to the left-right center D3 of the ink chamber 111C, and the offset of the left-right center C12 of the tank tube 115D relative to the left-right center D4 of the ink chamber 111D are different from one another in the rightward direction.

The distance L8 in the left-right direction between the left-right center C9 of the tank tube 115A and the right surface 103R of the left wall 103 defining the ink chamber 111A is greater than the distance L9 in the left-right direction between the left-right center C10 of the tank tube 115B and the right surface 103R of the left wall 103 defining the ink chamber 111B. The distance L10 in the left-right direction between the left-right center C11 of the tank tube 115C and the right surface 103R of the left wall 103 defining the ink chamber 111C is greater than the distance L11 in the left-right direction between the left-right center C12 of the tank tube 115D and the right surface 103R of the left wall 103 defining the ink chamber 111D. The distance L9 is also greater than the distance L10. The distance L12 in the left-right direction between the left-right center C9 of the tank tube 115A and the left-right center C10 of the tank tube 115B is equal to the distance in the left-right direction between the left-right center C10 of the tank tube 115B and the left-right center C11 of the tank tube 115C. The distance in the left-right direction between the left-right center C11 of the tank tube 115C and the left-right center C12 of the tank tube 115D is equivalent to the distance L12.

In the variation shown in FIG. 24, the distance in the left-right direction between the left-right center C9 of the tank tube 115A and the left-right center C12 of the tank tube 115D is shorter than if the left-right center of the tank tube 115A, the left-right center of the tank tube 115B, the left-right center of the tank tube 115C, and the left-right center of the tank tube 115D were respectively aligned with the left-right center D1 of the ink chamber 111A, the left-right center D2 of the ink chamber 111B, the left-right center D3 of the ink chamber 111C, and the left-right center D4 of the ink chamber 111D. Therefore, when providing a cover to cover the tops of the four tank tubes 115A, 115B, 115C, and 115D and the four communication openings 119A, 119B, 119C, and 119D, for example, the left-right dimension of the cover can be shortened.

Although omitted from the variation in FIG. 24, the ink tank 100 may also include the four annular walls 122A, 122B, 122C, and 122D. In this case, portions of the annular walls 122A, 122B, and 122C may be positioned outside the corresponding ink chambers 111A, 111B, and 111C in the left-right direction. Moreover, a portion of each of the annular walls 122A, 122B, and 122C may be at the same left-right position as the neighboring ink chambers 111B, 111C, and 111D.

In the embodiment described above, the centers K1, K2, K3, and K4 in the circular cross sections of the respective annular walls 122A, 122B, 122C, and 122D are offset forward from the centers T1, T2, T3, and T4 in the circular cross sections of the corresponding tank tubes 115A, 115B, 115C, and 115D. However, the centers K1, K2, K3, and K4 may be aligned with the centers T1, T2, T3, and T4.

In the embodiment described above, the front surface 101A of the front wall 101 has the three recessed surfaces 151 recessed rearward. However, the three recessed surfaces 151 may be omitted.

In the embodiment described above, the four upper marks 152A, 152B, 152C, and 152D and the four lower marks 153A, 153B, 153C, and 153D are located on the front surface 101A of the front wall 101, but the upper marks 152A, 152B, 152C, and 152D and lower marks 153A, 153B, 153C, and 153D may be omitted.

The top wall 104 of the ink tank 100 described in the above embodiment need not possess the sloped surface 104A, which slopes relative to the front-rear direction so as to extend downward toward the front. In this case, the four communication parts 113A, 113B, 113C, and 113D are provided in a surface along the horizontal plane.

The above embodiment includes the barrier wall 109, which protrudes diagonally upward and forward from the sloped surface 104A. However, the barrier wall 109 is not limited to this shape, as long as the barrier wall 109 can stop ink flowing down along the sloped surface 104A. Alternatively, the barrier wall 109 may be omitted.

In the embodiment described above, the tank cover 110 is provided to hold the ink tank 100 in a state where the tank cover 110 covers the front side of the ink tank 100 from the front, but the tank cover 110 may be omitted. In this case, the four through-holes 72 are formed in the ink tank 100 at positions corresponding to the four ink chambers 111A, 111B, 111C, and 111D. Specifically, tubular hole portions are provided to extend diagonally upward and forward from the front end portion of the top surface of the top wall 104 of the ink tank 100 such that each tubular hole portion surrounds a corresponding one of the annular walls 122A, 122B, 122C, and 122D.

In the embodiment described above, the left-right centers C1, C2, C3, and C4 of the respective annular walls 122A, 122B, 122C, and 122D are offset from the left-right centers D1, D2, D3, and D4 of the respective ink chambers 111A, 111B, 111C, and 111D. However, it is sufficient for a portion of the annular wall 122C to be located at a left-right position that is aligned with the ink chamber 111D. In other words, the annular wall 122C just needs to be positioned to span between the ink chamber 111C and ink chamber 111D in the left-right direction.

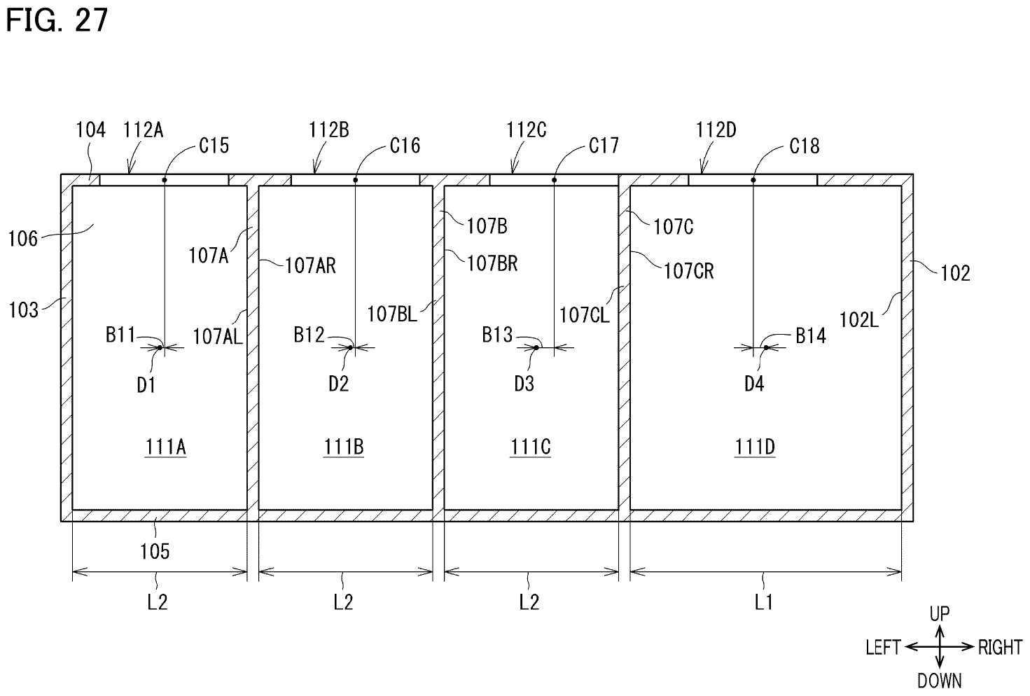

In the embodiment described above, the left-right centers C1, C2, C3, and C4 of the respective annular walls 122A, 122B, 122C, and 122D are offset rightward from the left-right centers D1, D2, D3, and D4 of the respective ink chambers 111A, 111B, 111C, and 111D. However, the left-right centers C15, C16, C17, and C18 of the respective atmospheric communication ports 112A, 112B, 112C, and 112D may be offset from the left-right centers D1, D2, D3, and D4 of the respective ink chambers 111A, 111B, 111C, and 111D, as illustrated in FIG. 27.

Specifically, the left-right center C15 of the atmospheric communication port 112A is offset slightly rightward from the left-right center D1 of the ink chamber 111A. The left-right center C16 of the atmospheric communication port 112B is offset rightward from the left-right center D2 of the ink chamber 111B. The offset amount B12 by which the left-right center C16 of the atmospheric communication port 112B is offset from the left-right center D2 of the ink chamber 111B is greater than the offset amount B11 by which the left-right center C15 of the atmospheric communication port 112A is offset from the left-right center D1 of the ink chamber 111A. The left-right center C17 of the atmospheric communication port 112C is offset significantly rightward from the left-right center D3 of the ink chamber 111C. The offset amount B13 by which the left-right center C17 of the atmospheric communication port 112C is offset from the left-right center D3 of the ink chamber 111C is greater than the offset amount B12 by which the left-right center C16 of the atmospheric communication port 112B is offset from the left-right center D2 of the ink chamber 111B. The left-right center C18 of the atmospheric communication port 112D is offset leftward from the left-right center D4 of the ink chamber 111D. The offset amount B14 by which the left-right center C18 of the atmospheric communication port 112D is offset from the left-right center D4 of the ink chamber 111D is smaller than the offset amount B13 and greater than the offset amount B12. The offset of the left-right center C15 of the atmospheric communication port 112A relative to the left-right center D1 of the ink chamber 111A, the offset of the left-right center C16 of the atmospheric communication port 112B relative to the left-right center D2 of the ink chamber 111B, the offset of the left-right center C17 of the atmospheric communication port 112C relative to the left-right center D3 of the ink chamber 111C, and the offset of the left-right center C18 of the atmospheric communication port 112D relative to the left-right center D4 of the ink chamber 111D are different from one another in the rightward direction. The atmospheric communication port 112B is an example of the first communication part. The atmospheric communication port 112C is an example of the second communication part.

In the variation shown in FIG. 27, the distance in the left-right direction between the left-right center C16 of the atmospheric communication port 112B and the left-right center C17 of the atmospheric communication port 112C is shorter than if the left-right center C16 of the atmospheric communication port 112B were offset leftward from the left-right center D2 of the ink chamber 111B, for example. Therefore, if a cover is to be provided to cover the atmospheric communication port 112B and atmospheric communication port 112C, for example, the left-right dimension of this cover can be shortened.

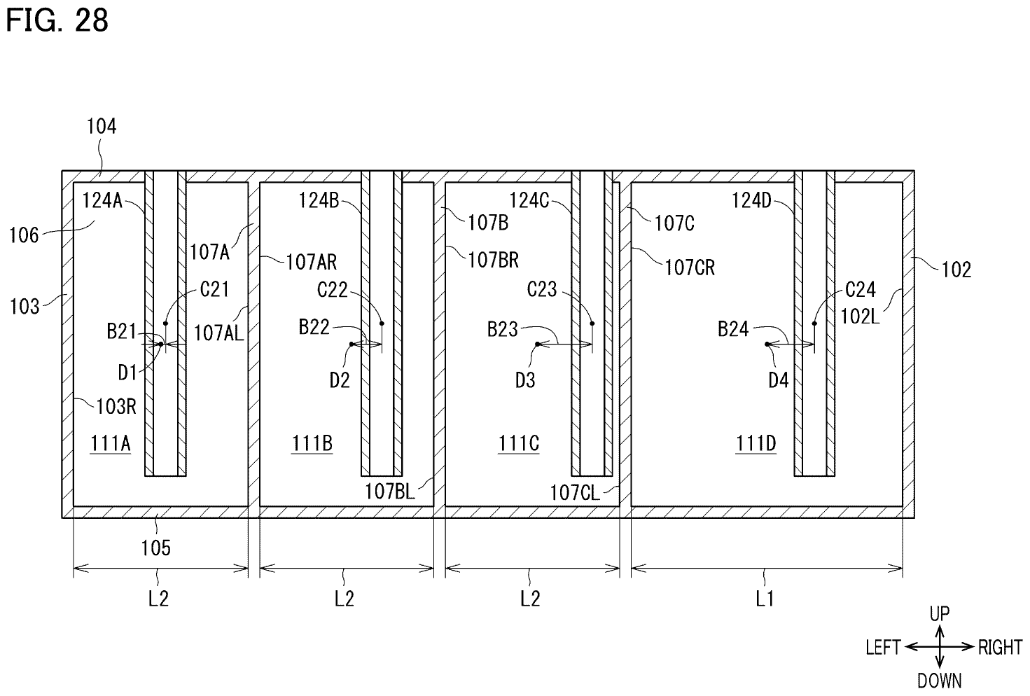

As shown in FIG. 28, the left-right centers C21, C22, C23, and C24 of the respective outflow tubes 124A, 124B, 124C, and 124D may also be offset from the left-right centers D1, D2, D3, and D4 of the respective ink chambers 111A, 111B, 111C, and 111D.

Specifically, the left-right center C21 of the outflow tube 124A is offset slightly rightward from the left-right center D1 of the ink chamber 111A. The left-right center C22 of the outflow tube 124B is offset rightward from the left-right center D2 of the ink chamber 111B. The offset amount B22 by which the left-right center C22 of the outflow tube 124B is offset from the left-right center D2 of the ink chamber 111B is greater than the offset amount B21 by which the left-right center C21 of the outflow tube 124A is offset from the left-right center D1 of the ink chamber 111A. The left-right center C23 of the outflow tube 124C is offset significantly rightward from the left-right center D3 of the ink chamber 111C. The offset amount B23 by which the left-right center C23 of the outflow tube 124C is offset from the left-right center D3 of the ink chamber 111C is greater than the offset amount B22 by which the left-right center C22 of the outflow tube 124B is offset from the left-right center D2 of the ink chamber 111B. The left-right center C24 of the outflow tube 124D is offset rightward from the left-right center D4 of the ink chamber 111D. The offset amount B24 by which the left-right center C24 of the outflow tube 124D is offset from the left-right center D4 of the ink chamber 111D is smaller than the offset amount B23 and larger than the offset amount B22. The offset of the left-right center C21 of the outflow tube 124A relative to the left-right center D1 of the ink chamber 111A, the offset of the left-right center C22 of the outflow tube 124B relative to the left-right center D2 of the ink chamber 111B, the offset of the left-right center C23 of the outflow tube 124C relative to the left-right center D3 of the ink chamber 111C, and the offset of the left-right center C24 of the outflow tube 124D relative to the left-right center D4 of the ink chamber 111D are different from one another in the rightward direction. The outflow tube 124B is an example of the first communication part. The outflow tube 124C is an example of the second communication part.

In the variation of FIG. 28, the distance in the left-right direction between the left-right center C22 of the outflow tube 124B and the left-right center C23 of the outflow tube 124C is shorter than if the left-right center C22 of the outflow tube 124B were offset leftward from the left-right center D2 of the ink chamber 111B, for example. Therefore, if a cover is provided to cover the outflow tube 124B and outflow tube 124C, for example, the left-right dimension of the cover can be shortened.

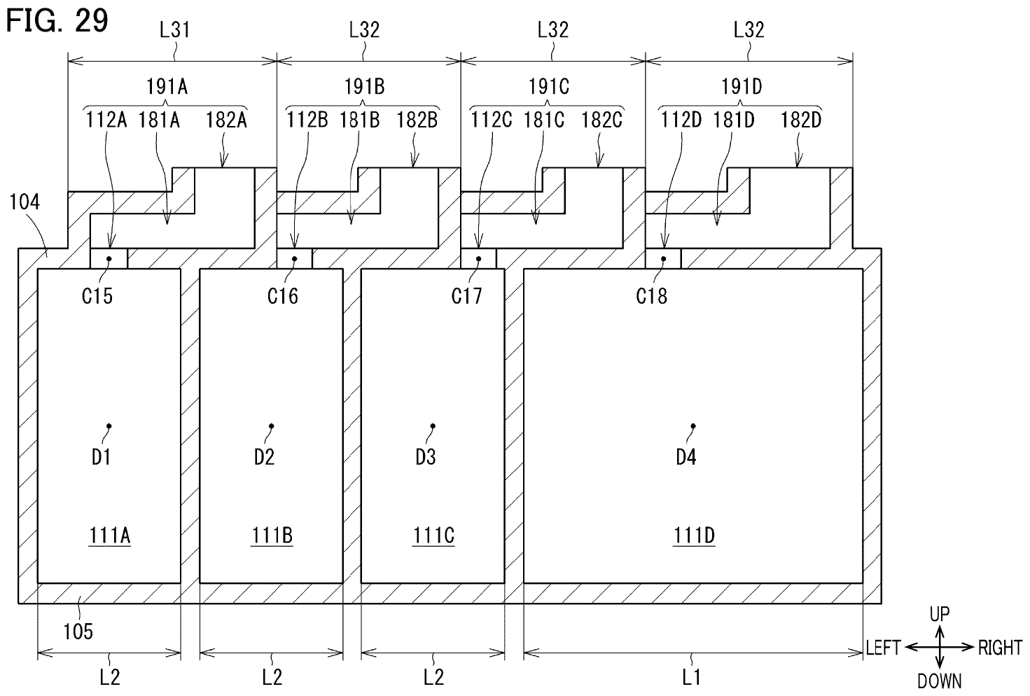

As shown in FIG. 29, atmospheric communication passages 181A, 181B, 181C, and 181D may be connected to the respective atmospheric communication ports 112A, 112B, 112C, and 112D. Atmospheric vents 182A, 182B, 182C, and 182D are positioned on the top ends of the respective atmospheric communication passages 181A, 181B, 181C, and 181D. Each of the atmospheric vents 182A, 182B, 182C, and 182D opens upward. The left-right position of the atmospheric vent 182A is aligned with the left-right position of the ink chamber 111B. The left-right position of the atmospheric vent 182B is aligned with the left-right position of the ink chamber 111C. The left-right position of the atmospheric vent 182C is aligned with the left-right position of the ink chamber 111D. The left-right position of the atmospheric vent 182D is aligned with the left-right position of the ink chamber 111D.

The atmospheric communication port 112A, atmospheric communication passage 181A, and atmospheric vent 182A configure a communication part 191A that provides communication between the ink chamber 111A and the exterior of the ink chamber 111A. The left-right length L31 of the communication part 191A is greater than the left-right length L2 of the ink chamber 111A. The atmospheric communication port 112B, atmospheric communication passage 181B, and atmospheric vent 182B configure a communication part 191B that provides communication between the ink chamber 111B and the exterior of the ink chamber 111B. The left-right length L32 of the communication part 191B is greater than the left-right length L2 of the ink chamber 111B. The atmospheric communication port 112C, atmospheric communication passage 181C, and atmospheric vent 182C configure a communication part 191C that provides communication between the ink chamber 111C and the exterior of the ink chamber 111C. The left-right length of the communication part 191C is equivalent to the left-right length L32 and is greater than the left-right length L2 of the ink chamber 111C. The atmospheric communication port 112D, atmospheric communication passage 181D, and atmospheric vent 182D configure a communication part 191D that provides communication between the ink chamber 111D and the exterior of the ink chamber 111D. The left-right length of the communication part 191D is equivalent to the left-right length L32 and is shorter than the left-right length L1 of the ink chamber 111D.

A portion of the communication part 191A is at a left-right position that is aligned with the ink chamber 111B. In other words, the communication part 191A is positioned to span between the ink chamber 111A and the ink chamber 111B in the left-right direction. A portion of the communication part 191B is at a left-right position that is aligned with the ink chamber 11C. In other words, the communication part 191B is positioned to span between the ink chamber 111B and the ink chamber 111C in the left-right direction. A portion of the communication part 191C is at a left-right position that is aligned with the ink chamber 111D. In other words, the communication part 191C is positioned to span between the ink chamber 111C to the ink chamber 111D in the left-right direction. The communication part 191D is at a left-right position that is aligned with the ink chamber 111D. The communication part 191A is an example of the first communication part. The communication part 191B is an example of the second communication part.

In the variation shown in FIG. 29, the communication part 191A spans from the ink chamber 111A to the ink chamber 111B in the left-right direction, the communication part 191B spans from the ink chamber 111B to the ink chamber 111C in the left-right direction, and the communication part 191C spans from the ink chamber 111C to the ink chamber 111D in the left-right direction. Therefore, the communication parts 191A, 191B, and 191C can be arranged in the top wall 104 without increasing the left-right length L2 of each ink chambers 111A, 111B, and 111C. Further, the communication part 191D can be arranged within the width of the ink chamber 111D. Since the atmospheric communication passages 181A, 181B, 181C, and 181D are made wide in the left-right direction, these passages can easily be configured with intricate shapes, for example, thereby suppressing ink stored in the ink chambers 111A, 111B, 111C, and 111D from evaporating or leaking out through the corresponding communication parts 191A, 191B, 191C, and 191D. Moreover, by making the atmospheric vents 182A, 182B, 182C, and 182D wide in the left-right direction, the atmospheric vents 182A, 182B, 182C, and 182D can easily be plugged with caps when such caps are provided.

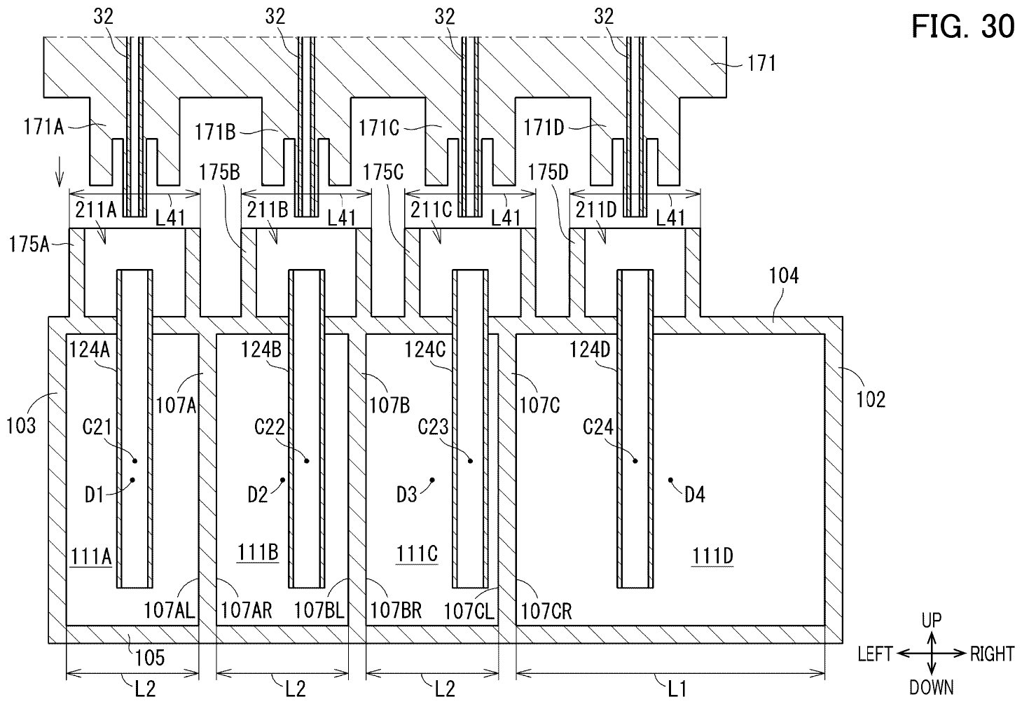

In the embodiment described above, the ink tank set 51 has the ink tank 100, the tank cover 110, and the tank caps 127, but the ink tank set 51 may also possess a connecting member 171. As shown in FIG. 30, the connecting member 171 is configured to connect the four ink tubes 32 to the four outflow tubes 124A, 124B, 124C, and 124D. The connecting member 171 includes four retaining parts 171A, 171B, 171C, and 171D for holding the four ink tubes 32 at equal intervals. In this case, four cylindrical insertion walls 175A, 175B, 175C, and 175D are provided on the top wall 104 of the ink tank 100, and the retaining parts 171A, 171B, 171C, and 171D can be inserted into the corresponding insertion walls 175A, 175B, 175C, and 175D.

The insertion wall 175A extends upward from the top wall 104 so as to surround the upper end portion of the outflow tube 124A. The left-right center of the insertion wall 175A is aligned with the left-right center C21 of the outflow tube 124A. The entire insertion wall 175A is at a left-right position that is aligned with the ink chamber 111A. The left-right length L41 of the insertion wall 175A is equal to the left-right length L2 of the ink chamber 111A. The insertion wall 175A and outflow tube 124A constitute a communication part 211A that provides communication between the ink chamber 111A and the exterior of the ink chamber 111A.

The insertion wall 175B extends upward from the top wall 104 so as to surround the upper end portion of the outflow tube 124B. The left-right center of the insertion wall 175B is aligned with the left-right center C22 of the outflow tube 124B. A portion of the insertion wall 175B is at a left-right position that is aligned with the ink chamber 111C. In other words, the insertion wall 175B is positioned to span between the ink chamber 111B and the ink chamber 111C in the left-right direction. The left-right length L41 of the insertion wall 175B is equivalent to the left-right length L2 of the ink chamber 111B. The insertion wall 175B and outflow tube 124B constitute a communication part 211B that provides communication between the ink chamber 111B and the exterior of the ink chamber 111B. The communication part 211B is an example of the first communication part.

The insertion wall 175C extends upward from the top wall 104 so as to surround the upper end of the outflow tube 124C. The left-right center of the insertion wall 175C is aligned with the left-right center C23 of the outflow tube 124C. A portion of the insertion wall 175C is at a left-right position that is aligned with the ink chamber 111D. In other words, the insertion wall 175C is positioned to span between the ink chamber 111C and the ink chamber 111D in the left-right direction. The left-right length L41 of the insertion wall 175C is equivalent to the left-right length L2 of the ink chamber 111C. The insertion wall 175C and outflow tube 124C constitute a communication part 211C that provides communication between the ink chamber 111C and the exterior of the ink chamber 111C. The communication part 211C is an example of the second communication part.

The insertion wall 175D extends upward from the top wall 104 so as to surround the upper end portion of the outflow tube 124D. The left-right center of the insertion wall 175D is aligned with the left-right center C24 of the outflow tube 124D. The entire insertion wall 175D is at a left-right position that is aligned with the ink chamber 111D. The left-right length L41 of the insertion wall 175D is shorter than the left-right length L1 of the ink chamber 111D. The insertion wall 175D and outflow tube 124D constitute a communication part 211D that provides communication between the ink chamber 111D and the exterior of the ink chamber 111D.

In the variation shown in FIG. 30, the four ink tubes 32 are inserted into the respective outflow tubes 124A, 124B, 124C, and 124D by inserting the retaining parts 171A, 171B, 171C, and 171D into the respective insertion walls 175A, 175B, 175C, and 175D. As a result, the ink tubes 32 are coupled with the corresponding outflow tubes 124A, 124B, 124C, and 124D.

In the variation shown in FIG. 30, the communication part 211B spans from the ink chamber 111B to the ink chamber 111C in the left-right direction, and the communication part 211C spans from the ink chamber 111C to the ink chamber 111D in the left-right direction. Therefore, the distance between neighboring communication parts 211A, 211B, 211C, and 211D in the left-right direction can be widened and the left-right dimensions of the communication parts 211A, 211B, 211C, and 211D can be increased without increasing the left-right length L2 of each of the ink chambers 111A, 111B, and 111C. This construction enables the retaining parts 171A, 171B, 171C, and 171D to be easily inserted into the respective insertion walls 175A, 175B, 175C, and 175D. Note that the ink tubes 32 need not be inserted into the respective outflow tubes 124A, 124B, 124C, and 124D, provided that the ink tubes 32 are connected to the outflow tubes 124A, 124B, 124C, and 124D via the connecting member 171.

In the embodiment described above, the annular walls 122A, 122B, 122C, and 122D and the outflow tubes 124A, 124B, 124C, and 124D are cylindrical in shape, but these components are not particularly limited to this shape. For example, the annular walls 122A, 122B, 122C, and 122D and the outflow tubes 124A, 124B, 124C, and 124D may have a rectangular tubular shape instead.

In the embodiment described above, each of the atmospheric communication ports 112A, 112B, 112C, and 112D has a rectangular shape that is elongated in the left-right direction, but these components are not particularly limited to this shape. For example, the atmospheric communication ports 112A, 112B, 112C, and 112D may have a circular or square shape instead.

In the embodiment described above, the positions of the keyways 74 relative to the inner curved surface 72A differ for each through-hole 72, but the positions may be the same for each through-hole 72. Alternatively, the keyways 74 may be omitted. When the keyways 74 are omitted, the key members 99 are also omitted from the liquid bottle 80.

In the embodiment described above, the positions of the key members 99 relative to the outer rear flat surface 94D differ for each liquid bottle 80 depending on whether the ink stored in the liquid bottle 80 is black, yellow, cyan, or magenta, but the positions of the key members 99 may be the same for each liquid bottle 80. Alternatively, the key members 99 may be omitted. When the key members 99 are omitted, the keyways 74 are also omitted.

In the embodiment described above, the protruding portion 139 provided on the rubber portion 129 of the tank cap 127 makes fluid-tight contact with the inner circumferential surface 123 of the corresponding annular wall 122A, 122B, 122C, or 122D. However, the protruding portion 139 may make fluid-tight contact with the end face of the corresponding annular wall 122A, 122B, 122C, or 122D instead.

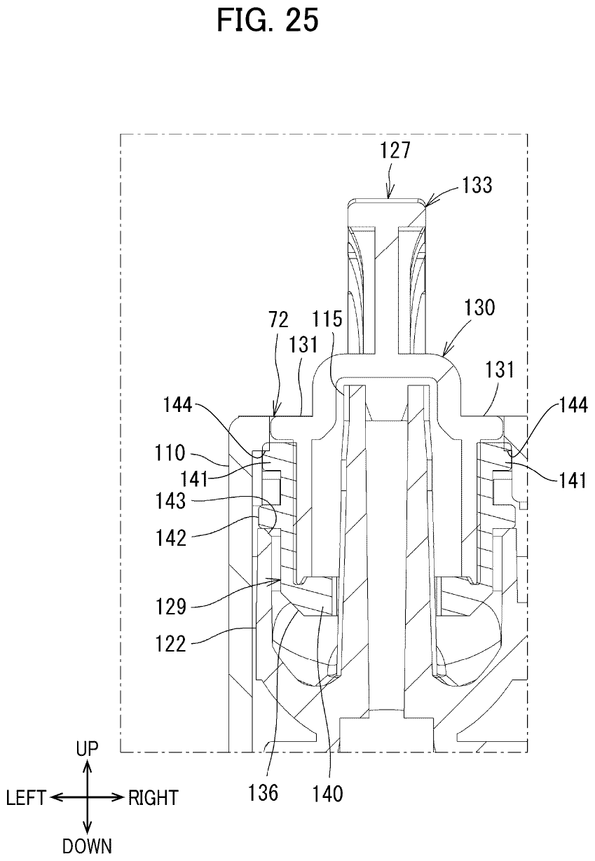

As shown in FIG. 25, the rubber portion 129 of the tank cap 127 has protrusions 141 and 142 that protrude annularly from the outer circumferential surface of the rubber portion 129. The protrusion 141 is positioned above the protrusion 142. In other words, the protrusions 141 and 142 are positioned apart from each other in the up-down direction. The outer diameter of the protrusion 141 is larger than the outer diameter of the through-hole 72 formed in the tank cover 110. The outer diameter of the protrusion 142 is larger than the outer diameter of an end face 143 formed on each of the annular walls 122A, 122B, 122C, and 122D of the ink tank 100.

When the rubber portion 129 of the tank cap 127 is inserted into the corresponding annular wall 122A, 122B, 122C, or 122D of the ink tank 100 through the corresponding through-hole 72 in the tank cover 110, the protrusion 142 of the rubber portion 129 passes through the through-hole 72 in the tank cover 110 and contacts the end face 143 of the corresponding annular wall 122A, 122B, 122C, or 122D. The protrusion 141 of the rubber portion 129 passes through the through-hole 72 in the tank cover 110 and contacts an underside surface 144 of the tank cover 110. The contact between the protrusion 141 and the underside surface 144 of the tank cover 110 keeps the protrusion 142 pressed against the end face 143 of the corresponding annular wall 122A, 122B, 122C, or 122D, thereby ensuring fluid-tight contact between the protrusion 142 and the end face 143.

Since the contact part 136 of the rubber portion 129 is in contact with the end face of the opening in the tubular portion 130, the rubber portion 129 is not displaced relative to the outer peripheral surface of the tubular portion 130, even if a force is applied to the rubber portion 129 when the protrusions 141 and 142 of the rubber portion 129 pass through the through-hole 72 in the tank cover 110.

In the embodiment described above, one flange 140 extends inward from the left portion of the contact part 136 and the other flange 140 extends inward from the right portion of the contact part 136, but the flange 140 may be provided only on one of the left or right portion of the contact part 136 instead.

In the embodiment described above, each of the communication openings 119A, 119B, 119C, and 119D in the ink tank 100 and through-holes 72 in the tank cover 110 has an outer shape that is circular on the front side and rectangular on the rear side, but these components are not limited to this outer shape. For example, each of the communication openings 119A, 119B, 119C, and 119D and through-holes 72 may have a circular or a quadrilateral outer shape instead.

The tank caps 127 may remain connected to the ink tank 100 or tank cover 110 when not mounted on the annular walls 122A, 122B, 122C, and 122D. In other words, the ink tank set 51 may have retaining members configured of arms or the like that hold, even after the tank caps 127 are removed from the corresponding annular walls 122A, 122B, 122C, and 122D, the tank caps 127 in a state where the tank caps 127 are connected to the ink tank 100 or tank cover 110. Additionally, the knob portion 133 of the tank cap 127 may have another shape or may be omitted entirely.

What is claimed is:

1. A tank for use in a liquid consuming device configured to consume liquid, the tank comprising:
a first surface;
a second surface facing the first surface in a first direction, the first direction corresponding to a widthwise direction of the liquid consuming device when the tank is in use in the liquid consuming device;
a third surface;
a fourth surface facing the third surface in the first direction;
a first storage chamber defined by the first surface and the second surface;
a second storage chamber defined by the third surface and the fourth surface, the second storage chamber and the first storage chamber being juxtaposed in the first direction;
a first communication part to which a first liquid bottle storing liquid is connectable, the first communication part providing communication between an interior of the first storage chamber and an exterior of the first storage chamber; and
a second communication part to which a second liquid bottle storing liquid is connectable, the second communication part providing communication between an interior of the second storage chamber and an exterior of the second storage chamber,
wherein, in the first direction, a center of the first communication part in the first direction is offset from a center of the first storage chamber in the first direction, and
wherein, in the first direction, a center of the second communication part in the first direction is offset from a center of the second storage chamber in the first direction.

2. The tank according to claim 1,
wherein a manner in which the center of the first communication part is offset from the center of the first storage chamber is different from a manner in which the center of the second communication part is offset from the center of the second storage chamber.

3. The tank according to claim 1,
wherein a length of the second storage chamber in the first direction is greater than a length of the first storage chamber in the first direction.

4. The tank according to claim 3,
wherein the first storage chamber is configured to store colored ink, and
wherein the second storage chamber is configured to store black ink.

5. The tank according to claim 1,
wherein the first communication part includes a first injection port through which liquid is injected into the first storage chamber; and
wherein the second communication part includes a second injection port through which liquid is injected into the second storage chamber.

6. The tank according to claim 5,
wherein the first communication part further includes a first tubular wall on which a first cap is mountable, the first tubular wall surrounding the first injection port, the first tubular wall having an opening, the opening of the first tubular wall being closed by the first cap when the first cap is mounted on the first tubular wall,
wherein the second communication part further includes a second tubular wall on which a second cap is mountable, the second tubular wall surrounding the second injection port, the second tubular wall having an opening, the opening of the second tubular wall being closed by the second cap when the second cap is mounted on the second tubular wall,
wherein a distance in the first direction between the first surface and a center of the first tubular wall in the first direction and a distance in the first direction between the third surface and a center of the second tubular wall in the first direction are different from each other, and
wherein a portion of the first tubular wall and a portion of the second storage chamber are at the same position in the first direction.

7. The tank according to claim 6,
wherein the first communication part further includes a first nozzle providing communication between the interior of the first storage chamber and the exterior of the first storage chamber,
wherein the second communication part further includes a second nozzle providing communication between the interior of the second storage chamber and the exterior of the second storage chamber,
wherein the first tubular wall surrounds both the first nozzle and the first injection port, and
wherein the second tubular wall surrounds both the second nozzle and the second injection port.

8. The tank according to claim 7,
wherein the first nozzle has an opening and the second nozzle has an opening,
wherein a center of the opening of the first tubular wall is offset from a center of the opening of the first nozzle toward the first injection port in a direction in which the first nozzle and the first injection port are arranged, and
wherein a center of the opening of the second tubular wall is offset from a center of the opening of the second nozzle toward the second injection port in a direction in which the second nozzle and the second injection port are arranged.

9. The tank according to claim 1, further comprising:
a partition wall having the second surface and the third surface, the partition wall partitioning the first storage chamber and the second storage chamber; and
a viewing wall through which the first storage chamber and the second storage chamber is visible from a front,
wherein the viewing wall has a recessed surface recessed from a portion of the viewing wall, the portion of the viewing wall being at the same position as the partition wall in the first direction, and
wherein the recessed surface has a sloped surface facing in the first direction.

10. The tank according to claim 9, further comprising:
a second sloped surface sloping relative to a front-rear direction to extend diagonally downward and forward, the front-rear direction being orthogonal to the first direction and an up-down direction; and
a rib protruding upward from the second sloped surface, the rib extending in the first direction,
wherein the first communication part is positioned on the second sloped surface, and
wherein the rib is positioned forward relative to the first communication part on the second sloped surface.

11. The tank according to claim 9,
wherein the viewing wall has a mark indicating a liquid level of liquid stored in the first storage chamber, and
wherein, in the first direction, the center of the first communication part in the first direction is offset from a center of the mark in the first direction.

12. A tank to which a liquid bottle storing liquid is connectable, the tank being for use in a liquid consuming device configured to consume liquid, the tank comprising:
a first surface;
a second surface facing the first surface in a first direction, the first direction corresponding to a widthwise direction of the liquid consuming device when the tank is in use in the liquid consuming device;
a third surface;
a fourth surface facing the third surface in the first direction;
a first storage chamber defined by the first surface and the second surface;
a second storage chamber defined by the third surface and the fourth surface, the second storage chamber and the first storage chamber being juxtaposed in the first direction;
a first communication part providing communication between an interior of the first storage chamber and an exterior of the first storage chamber; and
a second communication part providing communication between an interior of the second storage chamber and an exterior of the second storage chamber,
wherein a portion of the first communication part and a portion of the second storage chamber are at the same position in the first direction.

13. A tank to which a liquid bottle storing liquid is connectable, the tank being for use in a liquid consuming device configured to consume liquid, the tank comprising:
a first surface;
a second surface facing the first surface in a first direction, the first direction corresponding to a widthwise direction of the liquid consuming device when the tank is in use in the liquid consuming device;
a third surface;
a fourth surface facing the third surface in the first direction;
a first storage chamber defined by the first surface and the second surface;
a second storage chamber defined by the third surface and the fourth surface, the second storage chamber and the first storage chamber being juxtaposed in the first direction;
a first communication part providing communication between an interior of the first storage chamber and an exterior of the first storage chamber; and
a second communication part providing communication between an interior of the second storage chamber and an exterior of the second storage chamber,
wherein, in the first direction, a center of the first communication part in the first direction is offset from a center of the first storage chamber in the first direction,
wherein, in the first direction, a center of the second communication part in the first direction is offset from a center of the second storage chamber in the first direction, and
wherein a manner in which the center of the first communication part is offset from the center of the first storage chamber is different from a manner in which the center of the second communication part is offset from the center of the second storage chamber.
